(19) United States
(12) Patent Application Publication
(10) Pub. No.: US 2016/0117626 A1
(43) Pub. Date: Apr. 28, 2016

(54) System and Method for Determining a Ranking Schema to Calculate Effort Related to an Entity

(71) Applicant: EftMega, Inc., Long Beach, NY (US)

(72) Inventors: Evan Baken, Long Beach, NY (US); Katherine Baken, Long Beach, NY (US); Eric Weinstein, Baldwin, NY (US); Vincent Gravinese, Rockaway Park, NY (US)

(21) Appl. No.: 14/522,830

(22) Filed: Oct. 24, 2014

(51) Int. Cl. G06Q 10/06

(52) U.S. Cl. CPC G06Q 10/06398

(57) ABSTRACT

A method and system of ranking a performance entity is provided where a change in sales associated with the performance entity is calculated, the amount of sales relative to the amount of users hearing an album, the change in sales, listens and views indicative of a difference between a first point quantity is taken during a first time interval and a second point quantity taken during a second time interval, and a weekly sales result compared to an expected sales result. A list score is calculated based on a number of users associated with the performance entity, the number of users aggregated based on user data associated with a plurality of lists, a performance score of effort is calculated, and, based on the change in sales, the list score and the performance score, a relative ranking of the performance entity is determined among a plurality of performance entities.

### TECHNICAL FIELD

This application relates generally to systems, methods and apparatus for ranking an entity and more particularly to systems, methods and apparatus for ranking an entity such as a musician and/or group of musicians based on various factors by aggregating online retention, sales, and touring presence yielding a number representing an artist's overall effort that can be used to rank musicians across any location, scene and genre.

### BACKGROUND

Traditional forms of rankings in the music business are generally based on specific success measures (i.e., most requested song, most albums sold, highest grossing concert revenue, etc.) or a subjective highlighting based on money spent, i.e. reviews, buzz, or features.

Since the introduction of the Internet and illegal file sharing, music labels have continued to seek effective measures to reignite music purchasing. In the past decade, labels have had a paradigm shift where their focus lessened on how to use technology to create new ways to sell individual albums of recorded music in favor of subscription services that aggregate singles of entire catalogs of artists offering little income to artists and increasing revenue shares of merchandise and touring sales previously exclusive to these artists. This lack of artist focus and development has minimized the ability for artists to sell albums, create exposure, and tour.

Internet presence alone may not build fans. Traditional websites may place too much emphasis on instant gratification and short-term web objectives in order to quickly spread the word and generate buzz. Fans, however, may be built over time, converting them through internet promotions, touring, and content creation, providing for a more meaningful and vested relationship with the artist.

Music metric or data sites may focus analysis across all major web properties. However, most fan-related websites are led by an overly vocal minority of an artist's fanbase. Similar to a radio show where most callers may not represent the entire audience that listens to the show, traditional metrics measured across the Internet may not produce an accurate depiction of the artist's fanbase. Tracking a small subset of an artist fails to encompass the big picture that may prove a true fanbase. Metric sites may be concerned with Internet data to tailor marketing specifics. However, the Internet data may not be sufficient enough to affect the success of a band as they may focus too much on the elements controlled by the overly vocal minority. Their statistics may often be skewed.

One problem with the music industry is that single song consumption is increasing, but the revenue from single sales are low, and the cost to generate exposure from singles is expensive. The market is becoming congested since there are so many more singles being highlighted over albums. Further, since labels own the recorded rights to an artist's single the ability for most websites to aggregate singles results in licensing these rights from labels. Ad revenue may be used to hedge against losses from acquiring advance rights creating an industry with clutter, low artist exposure, and minimal profits.

Charts highlight traditional marketing of music. Television, radio and retail may rely on the idea that music can be ranked and customers can use such rankings to make informed purchase decisions. Compiling chart data used to be a difficult and specialized business with radio stations hand counting spins and retail stores using services to approximate album sales in local areas. The Internet has since made this data relatively easy to acquire. Any website can count and chart the music it hosts and third party sites can aggregate that data into more refined industry rankings. The problem is that Internet data can be easily manipulated, and charting has become an inconsistent measure of album sales and artist impact.

The following systems, activities and ways of quantifying or ranking artists are based on the idea of discovery. They determine how a consumer uses the system to discover music. The system results get ranked and charted and a consumer is exposed to music based on appealing criteria. However, there are problems associated with these systems. The problems are described herein.

Album Sales/Streaming activity—This activity provides a basic ranking of artists in order of album sales, streams, plays, views, downloads etc., over a specific time period. Time periods do not need to be concurrent.

Problems with Album Sales/Streaming activity—Labels and street teams may purchase their own artists' songs online (or in-store) so that significant sales cause their artists to chart and get more exposure on websites. This became a tradeoff of marketing dollars. For example, if a label spent $50,000 on a viral campaign that only sold 200 singles, it became better if the label bought 5,000 singles instead for $5,000 increasing chart position triggering consumers to believe in artist traction which may spur single/album sales. Additionally, labels may manipulate the reporting of local album sales. Sales may not be recorded in every store, so certain stores are weighted to include sales that were estimated from non-reporting stores. Labels may have album releases at heavily weighted stores, give away product, and get the benefit of higher sales estimates yielding an incredulous (first week) of sales affecting chart position. Additionally, labels and street teams have been known to sit online and constantly play or stream artist songs so that they appear to have popularity.

Broadcast Data System—This system provides airplay on radio and television (TV), including the gross impressions a song makes per play.

Problems with Broadcast Data System—Requests often come from fake profiles, or people working at a label posing as fans, often times sitting at a computer and clicking buttons repeatedly to simulate an interested fanbase.

Concert Ticket Revenue—The concert ticket revenue is a performance version of the album sales chart. The revenue can be ranked in terms of gross concert income or ticket sales over a time period, show, or specific tour.

Problems with Concert Ticket Revenue—Ticket sales may affect two things: future ticket sales and future rounds of negotiating with promoters. In order to create momentum for a show and/or tour, mitigate future risk and grab chart position labels may purchase unsold tickets and give them away direct or through third parties.

Reviews—Reviews are critical opinions of a specific song, album, or artist made by a specific person to his or her specific criteria.

Problems with Reviews—Reviews may be biased and based on favors and money. Labels may pay in one form or another for positive press. These opinions are subjective, without basis, and without a concrete systematic way for an artist to directly improve.

Playlists—Playlists are arbitrary lists of songs or artists created with specific criteria or by specific people. Often the creators of playlists have industry expertise or fame, while some allow for consumer creation.

Problems with Playlists—Playlists may fall into the same category as reviews. The underlying choices one makes for selecting an artist or song may revolve around how much money, press and exposure that person was given thereby removing the ability for an artist to chart on their own merits without financial assistance.

Musical Preference/Curation—This system is a limited ranking system whereby an algorithm attempts to match music to a consumer based on their musical listening or profile preferences.

Problems with Musical Preference/Curation—The basis of curation is that music is matched to a person based on a set of preferences. However, preferences can also be determined by money. Some songs seem to fit more moods/genres than others. In other words, songs may show up in more lists and categories if the service was paid more to do so. Additionally, if one believes music is personal, the reasoning and rationale for why someone likes one song may not be linked to a set of data points. Therefore, if the system recommends music a consumer doesn't like, then it is instantly proven ineffective and unnecessary. Curation may not create visibility. Rather, it may build a passive connection with an artist and a fan. Artists need vested fans to survive, to buy albums and share them with their friends, to buy concert tickets and merchandise. Vested fans may be the result of pure discovery; that is, the result of an audience finding music they like and the artist forming a real connection to that audience and engaging them free of manipulation.

Music Metrics—This is a system of data-mining that tracks and analyzes Internet impressions to quantify the results of some artist call to action. These are primarily for marketers working with advertisement campaigns, or industry representatives who attempt to identify Internet popular artists or “buzz”.

Problems with Music Metrics—Internet metrics form the basis of many third party decisions. In order to influence those decisions, labels may use street teams, interns, and Black Hat programs to increase web results. Labels may compensate people or set up electronic bots to browse the Internet and click buttons (i.e., vote for a particular artist/song, provide a thumbs-up or a high rank to a particular artist/song, etc.) in order to affect charting. This results in fake fan responses and initiatives that do not translate into future sales or concert tickets. These invisible votes affecting a ranking application do not have real validity in other applications. For example, a label may employ on a large scale, Black Hat Search Engine Optimization (SEO) scammers and pay them to generate a certain amount of clicks or website views in order to increase (fake) views on a website. Similar tactics can be used to increase likes on social media websites.

Requests—Request systems are websites, television shows and radio programs that allow consumers to request a song, album or artist.

Problems with Requests—Manipulation of requests is similar to Music Metrics. Street teamers and interns may create fake profiles and request songs/artists on the Internet or radio station phone lines. The burn rate of these fake requests is significant because the requests do not trigger sales. In other words, these “people” suddenly disappear when it comes time to buy an album or concert ticket.
Comments/Sentiment—This is a system allowing fans to post comments or sentiment about an artist, album, or song. Additional features include likes and dislikes, polls, and message boards.

Problems with Comments/Sentiment—Comments and message boards may be inundated with fake profiles. These sites also get spammed, thus, the activity may be virtually useless as it fills with fake appreciation and Internet Malware.

The issue for the aforementioned discovery tools is that they are unable to deliver what they promise: exposing artists and creating a model to encourage music exploration for consumers and increased consumption. Rather these ranking systems focus narrowly on certain ambiguous criteria, highlight few popular artists, and remove the consumer from any personal selection process thereby eliminating the vested interest a consumer should have with discovery. Music sales continue to decline. The domino effect for the industry as a whole is that without consumers purchasing enough music, labels stop investing in the majority of gambles (say 90%), focusing their efforts solely on what they feel are winners; the minority (say 10% of their roster) that drives their revenue. When so much revenue lies in the hands of so few acts, manipulation may come as a mechanism to protect the label investment. With discovery rooted in these charts, so narrowly focused, numbers may be affected and the tools have no meaning.

Discovery is not only hindered by manipulation but does not work in clutter. New artists may not break through when there are so many services offering the same visibility. New artists may not be able to afford significant marketing campaigns, or the expense of retail positioning. Further, they may be adversely affected when presented with opportunities based on a customer database that does not exist.

### SUMMARY

The present disclosure is directed to a method and system in which a change in sales associated with the performance entity (artist) is calculated, the amount of sales relative to the amount of users hearing an album, the change in sales, listens and views indicative of a difference between a first point quantity taken during a first time interval and a second point quantity taken during a second time interval, the change in sales, listens and views above expectation, a list score is calculated based on a number of users associated with the performance entity, the number of users aggregated based on user data associated with a plurality of lists, a performance score of effort is calculated, and based on the change in sales, the list score and the performance score, a relative ranking of the performance entity among a plurality of performance entities is determined.

These and other advantages of the present disclosure will be apparent to those of ordinary skill in the art by reference to the following Detailed Description and the accompanying drawings.

### BRIEF DESCRIPTION OF THE DRAWINGS

FIG. 1 depicts a network that may be used to provide ranking services, in accordance with an embodiment;

FIG. 2 depicts functional components of an exemplary user device, in accordance with an embodiment;

FIG. 3 depicts functional components of a server, in accordance with an embodiment;

FIG. 4 depicts functional components of a web service, in accordance with an embodiment;

FIG. 5 depicts an entity triangle, in accordance with an embodiment;

FIG. 6 is a flowchart of method of ranking an entity, in accordance with an embodiment;

FIGS. 7A-7H depict exemplary charts illustrating the calculation of weighted averages for various factors used to determine artists' overall rankings, in accordance with an embodiment;

FIG. 8 illustrates an exemplary key containing values used to determine a position value for each artist with respect to the artist's criteria for a show, in accordance with an embodiment; and

FIG. 9 shows components of a computer that may be used to implement certain embodiments.

### DETAILED DESCRIPTION

A (ranking) system is described that provides a more accurate depiction of an artist or band's ranking. Ranking manipulation is minimized. The ranking system analyzes the 90% gambles described above and realizes they may not be able to compete against the 10% winners. The ranking system discourages manipulation and allows artists to cut through the clutter without extraordinary spending.

System Goals: If an artist goes through this system, grows slowly picking up on the things we value for long term success, we estimate they will have an effective fanbase and long term career, which we can prove on subsequent album releases, historical and predictive data. Unsigned bands will have the same ability for exposure as signed bands. The money a band spends on promotion will not guarantee higher positioning. Our data will detect most manipulation. Our data will look at artist trends, album cycle trends, and seasonality and help predict future expectations.

The ranking system provides a solution to the problem that labels have been unable to correct with respect to selling artist albums. The ranking system provides artists with an exposure system in which they control their own positioning. Artists have a stronger connection with their fans, which in turn sells more albums and concert tickets. Artists maintain ownership and control of their product maximizing their revenue.

The ranking system is unique in that it tracks growth from the bottom up as opposed to success from the top down. Chart positioning and visibility is in the control of the individual artist. That is, the more work an artist does the higher they score. Growth is relative to each artist. Traditional success charts or positioning being very singular can easily be manipulated since they highlight such a narrow focus. The ranking system provides a way to quantify artists across multiple platforms. The result is that a new artist has the same opportunities for position as an established act across any style of music, in any locale.

The ranking system changes the landscape of music by effectively using sales and Internet statistics combined with “street” elements, eliminating misleading data. Exposure will be based on a compilation of an artist's entire career and growth. The effort used to generate web exposure, album sales, and concert tickets, in symbiotic congruency with one another will properly rank artists and maintain the integrity of the data. The ranking system provides a chart-based system reflective of artists who worked the hardest and deserve the most exposure.

The ranking system can create the artist exposure and fan connection missing from current music discovery tools. This may result in the elimination of traditional record deals, provide the consumer with albums priced competitively and return significant ownership and profits to the artist.

The ranking system can level the playing field between artists. Exposure may be based on effort. That is, the harder an artist works, the higher his/her chart position. The idea that a label or a sponsor can inject money into a band and immediately influence their metrics can be eliminated. People or bots that click buttons over and over again to simulate a fake fan base may no longer influence the rank of an artist.

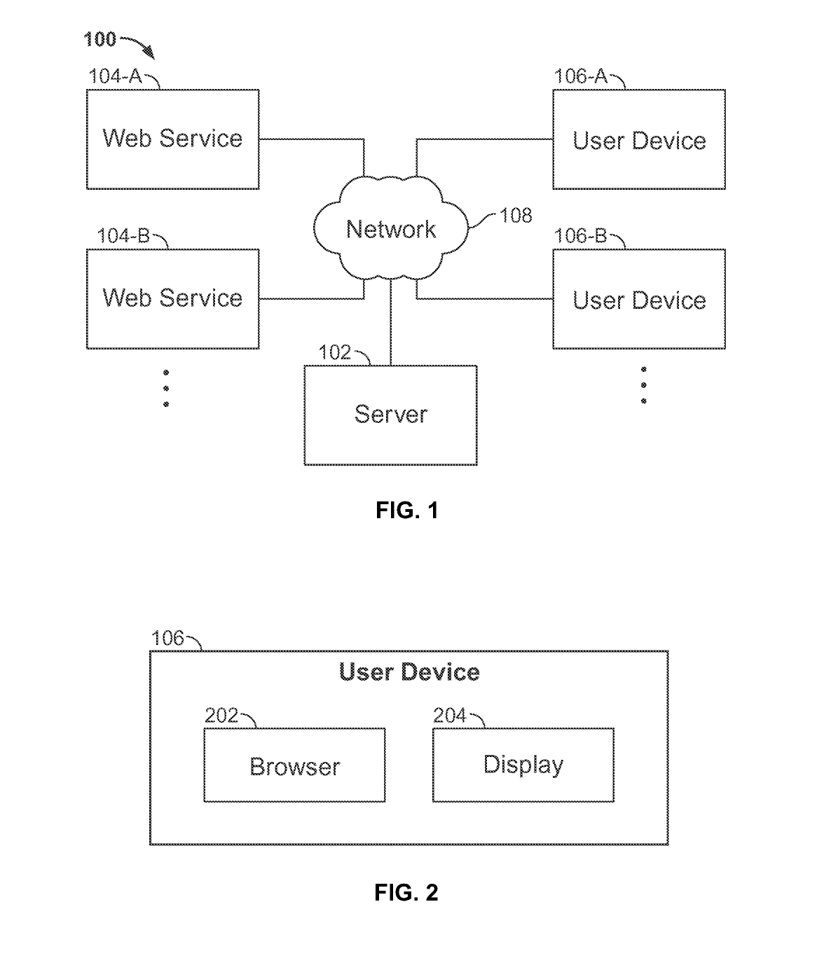

Referring now to the figures, FIG. 1 shows a system 100 that may be used to provide ranking services in accordance with an embodiment. System 100 includes a server 102, web services 104-A, 104-B, etc., user devices 106-A, 106-B, etc., and a network 108. For convenience, the term “web services 104” is used herein to refer to any one of web services 104-A, 104-B, etc. Accordingly, any discussion herein referring to “web services 104” is equally applicable to each of web services 104-A, 104-B, etc. Additionally, the term “user device 106” is used herein to refer to any one of user devices 106-A, 106-B, etc. Accordingly, any discussion herein referring to “user device 106” is equally applicable to each of user devices 106-A, 106-B, etc. System 100 may include more or fewer than two web services and user devices.

In the exemplary embodiment of FIG. 1, network 108 is the Internet. In other embodiments, network 108 may include one or more of a number of different types of networks, such as, for example, an intranet, a local area network (LAN), a wide area network (WAN), a wireless network, a Fibre Channel-based storage area network (SAN), or Ethernet. Other networks may be used. Alternatively, network 108 may include a combination of different types of networks.

In one embodiment, server 102 may host web services 104, which may include a website that can be accessed by user devices 106. In an alternative embodiment, web services 104 and associated and/or affiliated website(s) may be hosted by a different server. User device 106 may access a World Wide Web page on a website that is a part of web services 104 that may be viewed using a conventional web browser, for example. The website may provide a user with a variety of services including purchase of digital music, physical albums/CDs/DVDs, goods and/or concert tickets. The website may also provide forums, discussion boards, chat groups, mailing lists, review boards, etc. to users employing user device 106 via network 108.

User devices 106-A and 106-B may each be connected to network 108 through a direct (wired) link or wirelessly. User devices 106-A and 106-B may each have a display screen for displaying information. User device 106 may be any of a variety of devices including a personal computer, a laptop computer, a workstation, a mainframe computer, a wireless phone, a personal digital assistant, cellular device, a laptop computer, a netbook, a tablet device, a book reader, a smartwatch, smart glasses, other electronic body gear, etc. Other devices may be used.

In another embodiment, server 102 may obtain the point changes that occur on one or more websites by other means. Server 102 may use a weighted average of growth to determine and store data representing sales effort 310. In one embodiment, server 102 may obtain raw data relating to sales, listens, and visits of multiple bands/artists from one or more websites and may calculate the amount of sales, listens, and visits of each band/artist accumulated over a period of time (e.g., a day, a week, a month, a year, etc.) for each band/artist.

FIG. 2 depicts functional components of an exemplary user device 106, in accordance with an embodiment. User device 106 includes a web browser 202 and a display 204. User device 106 may also include a memory (not shown). Web browser 202 may be a conventional web browser used to access World Wide Web sites via the Internet, for example. Display 204 provides display of software applications, documents, images, webpages, and other data. Suppose that a user employing user device 106 wishes to view ranking data for his/her favorite band or artist. The user may access a website that is maintained by server 102 to view the ranking data displayed on a webpage.

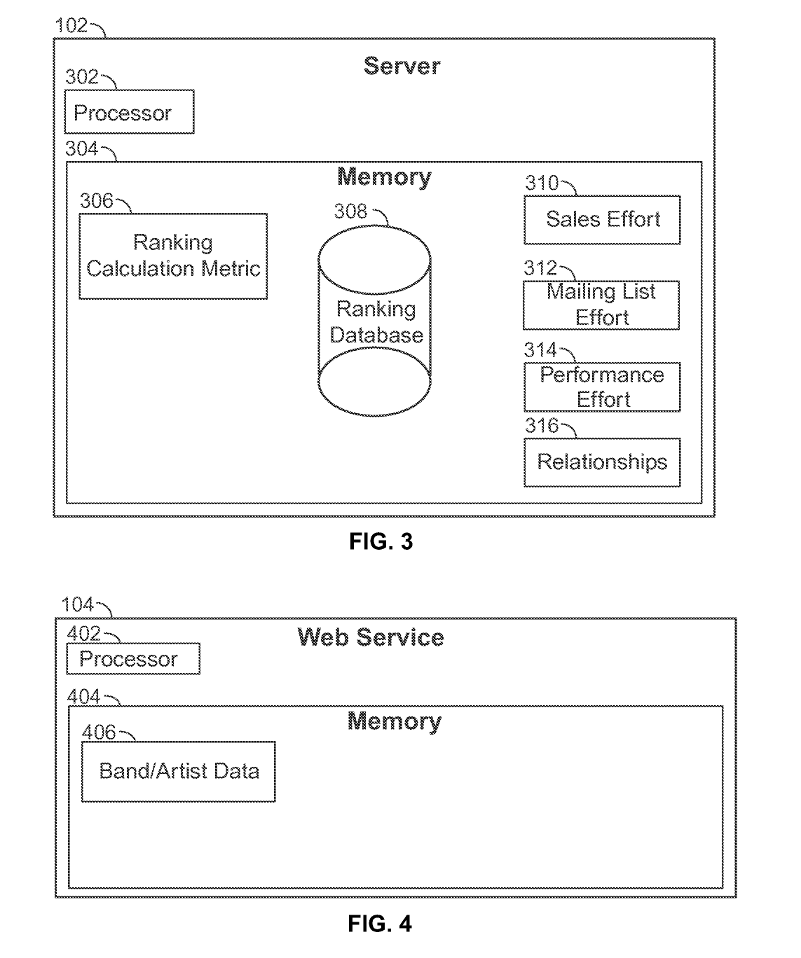

FIG. 3 shows functional components of a server 102 in accordance with an embodiment. Server 102 includes a processor 302 and a memory 304. Memory 304 includes a ranking calculation metric 306, a ranking database 308, data representing sales effort 310, data representing mailing list effort 312, data representing performance effort 314, and data representing relationships 316. In another embodiment, ranking database 308 may be located external to server 102 (not shown) and can be accessed by server 102. Server 102 may include other components not shown in FIG. 3.

In accordance with an embodiment, server 102 may provide access to or store software applications that store band/artist data for example. The data may be stored within webpages, word processing applications, spreadsheet applications, drawings or photo applications, video applications, audio or music applications, games, custom applications, or other software applications.

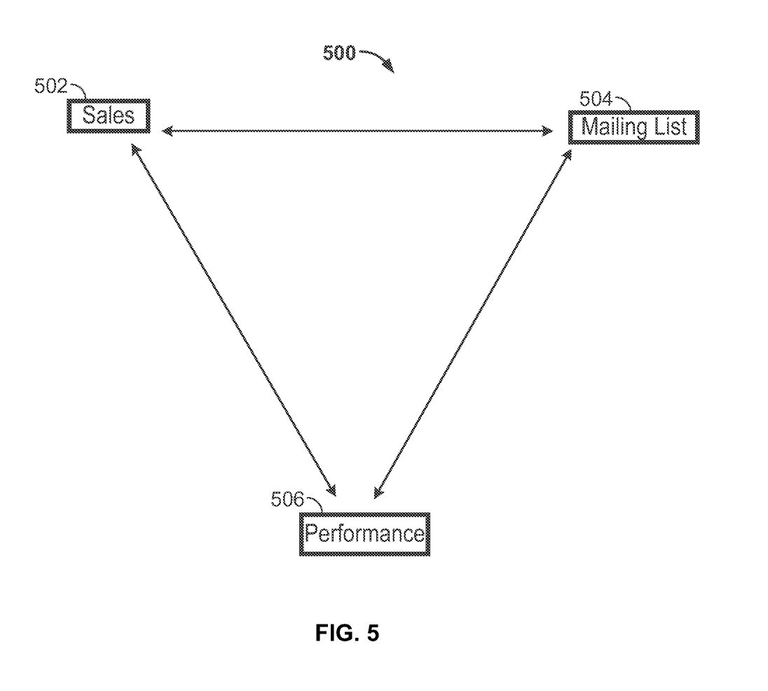

FIG. 4 depicts functional components of a web service 104, according to an embodiment. Web service 104 includes a processor 402, and a memory 404. Memory 404 may include band/artist data 406, as depicted by FIG. 4. Band/artist data 406 may be stored in any form. Band/artist data may be aggregated by web service 104 and accessed by server 102. Suppose that band/artist data 406 relates to sales data (e.g. album sales a band or artist grossed over a span of time). Server 102 may utilize the sales data to determine and store data representing sales effort 310. Similarly, if band/artist data 406 relates to mailing list information, server 102 may utilize the mailing list information to determine and store data representing mailing list effort 312. If band/artist data 406 relates to performance data, server 102 may utilize the performance data to determine and store performance effort 314. Details regarding effort calculations are described herein below with respect to FIG. 5.

In another embodiment, band/artist data may be stored external to web service 104 or may be stored at server 102.

FIG. 5 depicts an entity triangle, in accordance with an embodiment. Triangle 500 includes three criteria, one on each corner of a triangle. Sales 502 is based on an entity's album sales, and a consumer conversion from hearing an album to purchasing an album. Mailing list 504 is based on the entity's web exposure used to generate the mailing list. Performance 506 is based on the entity's performances be they live shows, TV and radio appearances, and other forms of live promotion. Each category (sales 502, mailing list 504 and performance 506) can be weighted and relationships between all three categories are utilized in order to create a ranking that can be applied to an entity (e.g. an artist or band). The entity may be categorized in any genre, scene and/or location.

In triangle 500, each category leads to the other two and relationships exist between all three categories. Suppose for example that a consumer discovers an artist on the Internet, buys the album, and attends a concert. Conversely, the consumer may see an artist at a show, then buys an album, then visits the artist's website and joins the artist's mailing list. Each point (category) on triangle 500 therefore is related to another point.

In an embodiment, triangle 500 representing an entity may start out as an isosceles triangle or equilateral triangle, but may change based on the data (which can be weighted) associated with each category. Based on triangle 500, it can be determined if one category has a more impactful value than the other, or a greater degree of difficulty, harder or easier to control, or a stronger candidate for effort than the others.

The triangle can be used in two ways in regards to the data. Predeterminations can be made as to the degree of difficulty of each corner of the triangle and each corner can be weighted accordingly and therefore give more points/credence to those areas which are considered to be the hardest or require the most effort to achieve. Thus, the type of triangle is changing depending on which sides/angles are larger. Conversely the triangle can be kept as an equilateral and the data trends may be allowed to indicate which categories are harder to increase than others. Since one of the measured variables is growth, it can be seen which category yields higher, faster, stronger growth and in that way no assumptions need to be made as the triangle is used to sum up all the effort to yield a measure based on data. The results will then show the shape of the triangle.

The following disclosure explains the use of the triangle in greater detail. If touring is assumed to be the most difficult aspect for a young artist, maybe twice as hard as selling albums and three times as hard as growing a mailing list, the weighting factors are adjusted accordingly to make touring worth twice the points of sales and three times the points of mailing list. Hence the touring angle of the triangle will be greater than the others, and since no one angle will then be the same, the triangle will assume a shape of a scalene triangle. If all sides/angles represent aspects of equal difficulty, no weighting factors are employed (or they are set to an equal value) and all triangle angles are kept—the triangle is an equilateral triangle. As mentioned prior, if at the start all categories/functions are assumed to be equal, input of new data yield the results, the triangle categories or degree of difficulty will change accordingly determining the shape, angles and side lengths.

Determining sales for an artist in the past were calculated based solely on sales of albums, singles, etc. that occurred at physical brick and mortar stores. Therefore, in order for an artist to create and promote a “successful” album, he/she needed to form a contract with a label that could provide distribution to get their music in retail stores. Now sales occur on the Internet without labels and without distribution. Therefore, an item may have a certain sales weight in the past based on sales made at physical stores, and now the sales weight may have changed due to various increased sales options available to consumers. Therefore, sales 502 may be calculated based on sales associated with an artist made at a particular e-commerce website, a particular store, or multiple websites and/or multiple stores.

One of the most common ranking systems in the music industry is sales based. In one embodiment, only sales that occur at a particular e-commerce website are analyzed. In another embodiment, sales occurring at various sources may be analyzed. However, it may be determined that analyzing sales data of too many sites/sources may cause confusion in the calculation of sales, and sales calculated on other third-party or non-trusted websites may have a higher chance of being manipulated/inaccurate. Additionally since the internet provides for a universal ecommerce location, the need for sales at multiple outlets in regards to music may prove unnecessary. Therefore, focusing on an artist selling on a particular website (i.e. a trusted website or a website associated with server 102) eliminates additional sales outlets that may be ineffective ways of calculating sales and directing an audience to make purchases. In one embodiment, the particular website may record the weekly sales and historical sales and provide the information to server 102. Other periods of time may be used to record sales.

The traffic generated to secure sales, or the conversion rate of unique consumer listens-to-buys may also be analyzed. This factor is the effectiveness of the artist hustling to get their product on the internet by doing interviews, promotions, contests, etc. In other words, the more work an artist does at getting his/her album out, the more sales he/she should have. Unique artist site visits converted into buys for each week (or the period of time) are scored. The first objective is to get someone to listen. The artist directs potential fans to their site or any site hosting their music. The effort to generate the listen may be determined. More importantly, the percent of users converted from listening to purchasing an album/song may be determined. Overall unique site visits converted into buys since an album/song has launched may also be analyzed. The percent changes in sales from week to week are recorded and various sales trends over a period of time are observed. Additional points can be given for positive sales trends to a band/artist and points can be removed for plateauing or declining trends over a period of time. Weekly sales above average also yield extra points. Sales at a point in time can be analyzed against current sales. The overall increases can be analyzed and recorded in order to determine volatility (e.g., how smooth or how sporadic they are). Album sales cycles can be observed and used for future expectations of an artist or similar artist. Each additional factor may be scored and weighted.

Since it is impossible to measure everything an artist does to generate sales, the focus is on the end result of those things, in this case directing the consumer to an artist page to hear a song/album and make a purchase. The sales and the conversion of the number of people that came to an artist's site to hear a song and then decided to purchase the album are recorded. In an era of embeddable sound files, artists can be encouraged to use one sound file and/or video file that gets embedded on every internet site possible. In turn a number of listens, click-throughs and conversions into sales can be more specifically and accurately tracked.

The weekly sales are analyzed from inception. The running totals are used week to week since people cannot un-watch or un-listen to something. Sales may not be reset with each album since resetting heavily rewards first week sales, plus it skews if a user buys an older album, one they bought after listening to and liking the artist's current release. Percent changes in listens, video views and unique artist site views measure how much work an artist is doing each week getting an album out to the general public. Percent change in sales measures how much the sales are increasing each week which we use to also gauge the number of people coming to the site each week to hear the album. These listens and views can also be measured against expectation and reward consistency. Total weekly buys over average buys measures expectations and rewards consistency and above board performance. The objective is not to discourage steady album sales while encouraging growing album sales. Finally, total buys over unique page views measures the conversion of casual listeners to fans, people who now hear an album and are so motivated to purchase one.

Sales that come from counterfeit sources skew numbers to jump-start a chart. In the ranking system, data is analyzed in different positions in time. Therefore, manipulation, if any, only works short term. For example, if a party is purchasing albums in order to falsely raise the popularity of a band/artist by increasing sales, it is difficult to continue to buy up music over a long period of time. The odd jump in sales data will be highlighted. When combined with other characteristics (of the triangle), the jumps are analyzed to determine legitimacy. For example, sales jumps have to be linked to either increased web traffic or performance traffic so manipulation is avoided and eliminated by observing the sales trends against the other two categories. Artists will not get the benefit of strong sales since they will be offset by poor mailing list and weak touring numbers. There is no need to focus on one week at a time. If a consumer sees a band perform at a festival they may not purchase the album that same week. They may visit the artist site a week later, and may purchase the album a week later after many listens. The described triangle will even this out. The strong touring one week may be balanced out by the strong mailing list in week two and the strong purchases in week three.

Additionally poor sales with many listens could also indicate people are coming to the site but do not like what they hear. An artist may be strong at directing attention for their album, but may not be strong in releasing an album their audience wants to purchase.

A Mailing List does not reflect simply a person putting their name on a mailing list, or signing up to be an Internet friend, follower, or fan. A Mailing List represents the efforts made by an artist on the Internet whose intention is to get a consumer to join the mailing list. The mailing list represents the call to action whereby the artist directs its fans towards a few small goals—to join/subscribe to the artist, buy an album, or see the artist live. No matter the activity of the artist on the Internet, eventually each item or promotional piece leads the consumer to the artist page whereby they are asked to join some type of mailing list. We can analyze the results of this effectiveness (that is, the increasing or decreasing rate at which new consumers sign up).

One advantage of providing instant metrics is that sponsors can direct their marketing efforts. However, new artists may not necessarily have sponsors and may not have positive instant metric data. Therefore, one goal of such new artists may be to cultivate the mailing list(s). A Mailing List will reflect the overall popularity of an artist over time, and how effective they are at directing subscribers.

A change in mailing list size may be quantified from week to week from any number of sites that include a database providing a list or number of the artist's fans. By using multiple mailing list sites, potentially weighing each one in terms of relevance, effort can be determined, and the growth in those mailing list numbers from week to week can be recorded. Additionally, mailing list size week to week can be compared against an expectation of weekly mailing list size and reward artists who consistently add user signups. Similar to sales, there is no need to measure all the things an artist does each week to draw people to the mailing list, the focus is on the end goal, signing up.

MailingListEffort can be determined using one or more of the following equations:

MailingListEffort=WeightedAverageSite1MailingListChange+WeightedAverageSite2MailingListChange+ . . . WeightedAverageSiteNMailingListChange (E1)

Under this equation any number of mailing list sites is identified and the total number of subscribers each one has, every week, is recorded. Each site is assigned a weighting value based on its relevance or significance. The growth in mailing list subscribers is calculated from week to week. By comparing growth relative to one's own size the playing field is leveled and merely rewarding big numbers that support big acts is avoided. An artist with 1,000,000 fans can add 1,000 new fans easier than an artist with 500 fans, but it is much harder for any artist to double their mailing list in size or grow it substantially in relation to their existing size. Under this formula it is determined what sites are the most important for an artist to be on, and it is determined whether it is acceptable for an artist to be strong on some and weak on others.

In other words, the MailingListEffort can be calculated as a total of all the weighted average mailing list changes made at all of the sites (e.g., Site 1, Site 2, . . . , Site N).

The weight of the sites depends on the relevance or strength of the sites that are monitored. Additionally, one site can be substituted for another if the site's impact changes. Further the number of sites can be increased or decreased depending on the state of the industry, or specific sites relevant to each artist can be chosen since certain websites support different styles of music than others. What the site represents is irrelevant since only the weekly growth in subscribers is measured.

Since growth from inception is irrelevant, the focus is on week to week growth, since over the course of an album cycle there are up times and down times. Slower weeks have to be accounted for when a band is off the road, or perhaps writing and/or recording. If only documented growth from inception is recorded, the bigger bands that have been on the site longer are rewarded. However, the main objective is to reward those artists who are working the hardest to grow week after week.

Another way to calculate the MailingListEffort is without the use of weighting values. If every site is deemed to be equal, feedback is less subjective, or no one site substantially more important than the rest, the total the amount of Mailing List subscribers for each site is calculated as presented in the formula below and the percent change in growth from week to week is recorded.

MailingListEffort=% Change in total mailing lists for the week (E2)

In yet another equation to calculate the Mailing List effort the average growth of the mailing list from inception is calculated and the weekly growth above or below the running average is recorded.

MailingListEffort=Weekly Adds/Average weekly total subscribers from inception (E3)

This calculation rewards consistent growth whereas the other two reward increasing growth.

Under MailingListEffort any one equation can be chosen or components of all three can be added and some or all components can be weighted if these components are deemed significant. Each one represents some measure of performance (weekly growth, consistent growth etc.) so adjustments can be made to determine the right mix in quantifying the effort we feel is most representative of properly growing the Mailing List.

In one embodiment, performance is the theory that an artist should play any show they can. Touring is the commitment an artist makes on their career sacrificing money, time, and relationships to grow their fan base. Traditional touring charts are difficult to analyze, as the Agent/Promoter industry looks for the bankability of each artist, availability of each artist, the compatibility of each artist, and the concert traffic around various dates. Traditional touring charts focus on ticket sales and gross revenue, however, Performance 506 is based on touring in terms of growth and making the most of touring opportunities. Current performance metrics do not provide the entire story of an artist in a market.

The idea of performance can be a traditional concert, a festival, or a media (TV, radio, Internet) spot. The following may be analyzed: markets played, venue sizes, the percent of tickets sold in each show, distance from home/travel commitments, slots in the bill, growth in a market, concert merchandise sales per head, and the amount of people in attendance when a band performs. For upstart acts, scoring is determined based on criteria not previously charted. These include basement shows, local bar performances, college fraternity performances, free concerts, etc. History of artist performance is analyzed in a certain area or areas. It is determined whether the audience is growing or declining with each performance. If an artist is a main support on a successful tour, it is determined whether they can come back to a market and achieve decent numbers as a headliner.

Charting ticket revenue can be skewed because of expensive ticket prices and label buy-ins. For a growing artist it may be better to be playing to more people and retaining those people with each subsequent show, while achieving strong numbers in every venue, at every capacity. The history of the artist can be determined in each market, along with the degree of difficulty of the performance. More points may be assigned to artists touring regionally than those that play locally due to the higher degree of difficulty with respect to touring. Additional information relating to an artist can be analyzed including how many shows they perform in a given period.

Since not every data point can be measured simply on growth, a key is used to analyze performance data. Growth in a market is being considered—it can be a simple percent change of a current performance over a previous performance or a previous average of performances. However, other data is better suited to the summary points. First, venue size is broken down as a percent of 1,000. The described system and method must reward artists for playing bigger shows because bigger shows require more production, staffing, performance time, etc. It is to be understood that the chosen value of 1,000 is an arbitrary number and that it can be changed to be better in-line with the other values or it can be weighted to have the same result. Position in a show is also the consensus of how responsible an artist is for the people seeing him/her in a room, and how filled the room is at the time of the performance, so this data is used to determine the impact of position. The radius an artist travels from home as a percent of 50 miles is also calculated. It is to be understood that the selected value is arbitrary but it serves to reward any artist who travels farther to play a show. This figure can also be weighted or changed per artist, meaning a higher or lower percentage can be used for bands that live in areas that are harder to tour in (based on climate or venue availability, etc.). The percentage of tickets sold in a market can also be estimated if this data is not readily available. If exact data is required, promoters can be contacted to obtain this data, however, certain assumptions can be made about how many fans will attend a show based on the strength of the market (tour history), mailing list numbers, and the artist's album sales in the market. Also, outlets that have difficult capacities to determine like small bars or basements, radio or internet audiences can be approximated. No points need to be added for playing more shows in a week as this variable is already taken under consideration since the total tour metrics is calculated on a weekly basis. The more shows an artist plays the more points they will get for the categories mentioned above.

Concert position is based on the fact that if an artist is a headliner the majority of the audience is considered to be attending to see this particular artist, whereas an opener on a (i.e. four band) bill is responsible for almost no one in the room. Additionally, when an opener performs the venue hall is never filled to its capacity because people take their time filling seats in anticipation of the headliner. The goal of the support artist is to impress upon enough people in attendance that listeners either buy their album, visit their website, or return when they play again.

In the described system and method, the Venue Size metric can generally replace the Tickets Sold metric. The idea is that an artist puts tickets on sale to a room they feel they are going to sell out. So an artist looking to sell 500 tickets won't play a venue that holds 1,000 people as it will look bad and the promoter will lose money. Calculation of tickets sold can be generally avoided since venue size combined with position on a show can provide a sufficient approximation as to how many people actually saw the band. If the data which proves otherwise becomes available, specific data about tickets sold and the percentage of capacity sold can be added. Additionally, sometimes artists deliberately play small rooms. This can be the desire to play a certain historical venue or the idea of a more intimate show. The described system and method does not penalize artists for making this choice. Nevertheless, the described system and method allows for review of previous tour dates, mailing list and sales data to see if this move is intentional, i.e. to see if the artist has the other pieces that would indicate playing bigger rooms traditionally in that market. Further, points and weighting factors can be doubled for small bands which sell tickets on headline shows to reward them for growth, which in turn can be capped at a certain milestone, something established bands have a harder time doing since their touring numbers often plateau over time. Also merchandise sales can be looked at as a percent of the audience in attendance. This per head amount measures how much each person spent on the artist for each show. If we are able to get this data without manipulation it may also prove how responsive an audience is for a particular artist. A strong amount, say $10/head highlights a good artist/fan relationship while a smaller $1/head amount may indicate a less vested fan base.

The “Distance from Home” metric is important because every artist should be strong in their market, but traveling outside ones locale or state requires much more effort. Certain areas like Utah are much harder to perform in than New York because the amount of available markets is much less, and are much farther apart from one another. Additionally, places like Southern California have no winter so the ability to play shows year round is easier. The world can be divided by regions, and bonus points can be assigned for traditionally difficult touring areas. Also, bonus points may be added for international touring (i.e. Canada) or seasonality (Winter vs. Summer). Certain point values can be used to test the validity of regional and seasonal touring obstacles and artist's efforts may be rewarded or penalized accordingly.

The “Growth in a Market” metric is important as an indication that an artist is doing the work to constantly bring new people to a market and impress current fans enough to return. Growth may be capped to only reward small bands. Alternatively, growth may be set to be unlimited based on the theory that if growth is measured based on current size, as a band gets larger its harder for them to grow at the same rate or percentage so the band will not earn points at that level anyway. Also, comparing growth levels the playing field as traditional measures of tickets sold and gross revenue only support larger acts. Again, the described system and method awards points for venue size which is based on a growing audience, which is why the value at which extra points are awarded for market growth may be preferably capped.

Internet manipulation, fake profiles, and Black Hats discussed above skew data. In order to avoid skewed data, the following strategies may be implemented. First, artists are not provided with a list of which specific sites are being monitored to gather data and sites may be changed without providing any warning to the artists. This way, an artist does not know which sites affect their rankings. Second, mailing list data monitored on websites is used as a partial number which when combined with other sales and performance data eliminates or reduces manipulation. One action affects the other, so if a mailing list is made up of fake names, it will not properly impact the other sides of the triangle.

Performance manipulation is a very difficult way to fabricate results. Aside from buying up concert tickets, a party has no other way to simulate someone attending a show. The triangle may also indicate any anomalies. Strong web presence and album sales that do not link to concert tickets may indicate falsification. Performance trends will ensure the data recorded is accurate and real.

Returning to FIG. 5, relationships between Sales 502, Mailing List 504 and Performance 506 are correlated to calculate the effect of each category on an artist's career while hedging against manipulation. Each category of the triangle affects the other, and the data should make sense. The data is searched for indicators of fraud, by noting that positive trends in time affecting one category must affect the other categories. Also data collected between the three categories over time may indicate album cycle trends which may create expectations for artists and highlight deviations from those expectations.

Artist conversions from one category to the other are then measured. Based on the data, any period of time can be analyzed to determine if a show increased web traffic and album sales, or if a large jump in web presence increased ticket sales, etc. Suppose that an artist performed a show in Missouri. It is determined whether a show in St. Louis increased album sales in that market. Suppose that the artist was featured on a Cleveland radio station. It is determined whether a performance on the Cleveland radio station bumped ticket sales in that market. It may also be determined whether an Internet campaign produced genuine results.

Comparisons may be made among all artists, artists of relative size, or artists in each scene. Patterns and irregularities can then be isolated and points may be given to those artists who move each relationship in the same direction. Key events or key factors that affect large groups of artists can be defined and isolated. Results of future artists can be anticipated/predicted and it can be determined whether the current occurrences are correct by monitoring these results against a catalog of events that happened prior.

The Effort metric can be determined by analyzing Sales 502, Mailing List 504 and Performance 506 metrics to yield a universal scoring system that can chart artists effectively on the work they do to grow their careers on a controlled, level playing field.

If all three sides of the triangle are monitored and the individual metric scores are added up each week, the following may happen: 1. A legitimate artist will see spikes across all three sides at once and get the benefit of a really high week score. 2. A legitimate artist will see a high score for one or more areas one week and a high score for a different area the next week as these scores relate but did not correlate exactly due to timing issues. 3. Someone manipulating points will have a high score in one category and when combined with very low scores on the other two will ultimately have low overall scores and not chart nor get the benefit of positioning based on even data across all three sides. The described system and method, in an automated mode, can monitor weekly scores to highlight inconsistent increases from one side to the next, as well as identify unusually high scores relative to an artist's average score in any particular side. The abnormal spike can then be investigated and the legitimacy of the cause can be identified.

Over time large data sets of all the artists or specific data points of one artist can be used to generate expectations, probabilities, distributions, and variances to further analyze what look like typical results for an artist over time (album or touring cycle). These common equations and relationships may help determine anomalies while also providing artists with a basis for future decision making.

Referring again to FIG. 5, as noted earlier, all ends of triangle 500 are used to determine an entity's effort by using the following equation:

Effort=SalesEffort+MailingListEffort+PerformanceEffort (E4)

The values recorded in the three separate triangle angles are added together to present the complete picture of effort. Simply adding each side does not mean each side is equal. The collected values have to be analyzed to see if they fall in a similar range for each category and only then can these values be added up (if analysis indicates that these values represent what it is intended to represent).

Calculations of each of Sales, MailingList, and Performance may be weighted. The weighting factors can either cause each of the three categories to be equal or make sure one or more categories is emphasized over the others. Suppose that the Sales category has a weight of 5, the Mailing List category has a weight of 3 and the Performance category has a weight of 2. The equation incorporating these weights is as follows:

Effort=5×SalesEffort+3×MailingListEffort+2×PerformanceEffort (E5)

Under this scenario, if the assumption is that the data collected on each factor is even, the weighting factors are added to any category that is considered to be harder. In other words, if touring is considered to be 5 times harder than to grow a mailing list, the touring results are multiplied by a weighting factor of 5. However, if a determination is made that the original data collected is not even, weighting factors are assigned accordingly to even out the results. For example, if all the sales data returns a score of 1, and the tour data returns a score of 10, adding these two amounts means that the touring is valued 10 times more than sales. So, the weighting factor of sales can be increased by 10 or the weighting factor of touring can be decreased by 10 to get these variables closer to even. If no weighted average was required, then all weights could be set as “1” yielding a simplified equation.

Effort=NormalizedSalesEffort+NormalizedMailingListEffort+NormalizedPerformanceEffort (E6)

Under this equation the assumption is that the three factors are equally as important and the best way to compare apples to apples is to normalize each set of numbers. The average and the standard deviation from each number set is computed and a standardized value set is calculated such that each set of unique numbers is revised as a set of similar numbers. That way all three factors are summed up without worrying about weighting factors. The normalizing uses averages and looks at each item compared to the average of the whole, so it's good to use over large data sets where the results are self-evident. If there is no knowledge that touring is 5 times harder than growing a mailing list, this function will either support or disprove that estimation.

Effort=RankedSalesEffort+RankedMailingListEffort+RankedPerformanceEffort (E7)

Another way to tally the results is to simply look at each category on its own and rank the artists separately. This keeps each factor equal assuming all parts of the triangle are similarly as hard to grow. Then the total of the ranked results which yields a total ranking is determined supporting the notion that each factor is as important as the other. For example, if out of 50 artists one act ranks 5 out of 50 in mailing list, 10 out of 50 in touring, and 1 out of 50 in sales, the total rank for that artist would be 5+10+1 or 16. That score of 16 would then rank the artist among all the other “three part scores” from the 50 artists in the data set. Since the better numbers in this scenario are lower numbers the rank of the results is reversed to calculate the revised ranking.

Finally, the described system and method provides for the ability to penalize artists that are considered to receive more assistance than others. For example, major label artists usually have in-house promotion, radio, new media, touring departments, etc. and it would seem that most artists on major labels have more access to resources and more ability to succeed than artists without a label. Accordingly, the described system and method provides for an option to penalize the major label or indie label artist to create a more level playing field with an unsigned artist. For example, if the assumption is that for an unsigned artist to sell 50 albums is 10 times harder than for a signed artist to sell the same number of albums, the described system and method can assign a weighting factor of 10 to multiply the unsigned artist score by the weighting factor or to reduce the major label score by 10 to equalize the album sales metric. Such strategy encourages unsigned artists and fosters their growth against established major label stars which will help them gain visibility in the long run.

The described system and method also has the ability to monitor an artist's effort from inception as opposed to weekly effort. Another metric can be added which monitors the artist growth over time to see how each artist performs relative to one another artist based on the same time criteria. For example, the described system and method can monitor artists to determine how each artist performed after 20 weeks and reward those artists whose results are above average or above projected expectation. The monitoring tool of the described system may be used to help artists understand why their position is what it is, meaning why they may or may not be higher than they think.

In an embodiment, calculations of effort of Sales, Mailing List and Performance are performed by ranking calculation metric 306, depicted in FIG. 3. In other embodiments, these calculations may be performed by web service 104 or another device. Server 102 may store effort information for sales as data representing sales effort 310, information for mailing list as data representing mailing list effort 312, information for performance as data representing performance effort 314, and information for relationships as data representing relationships 316.

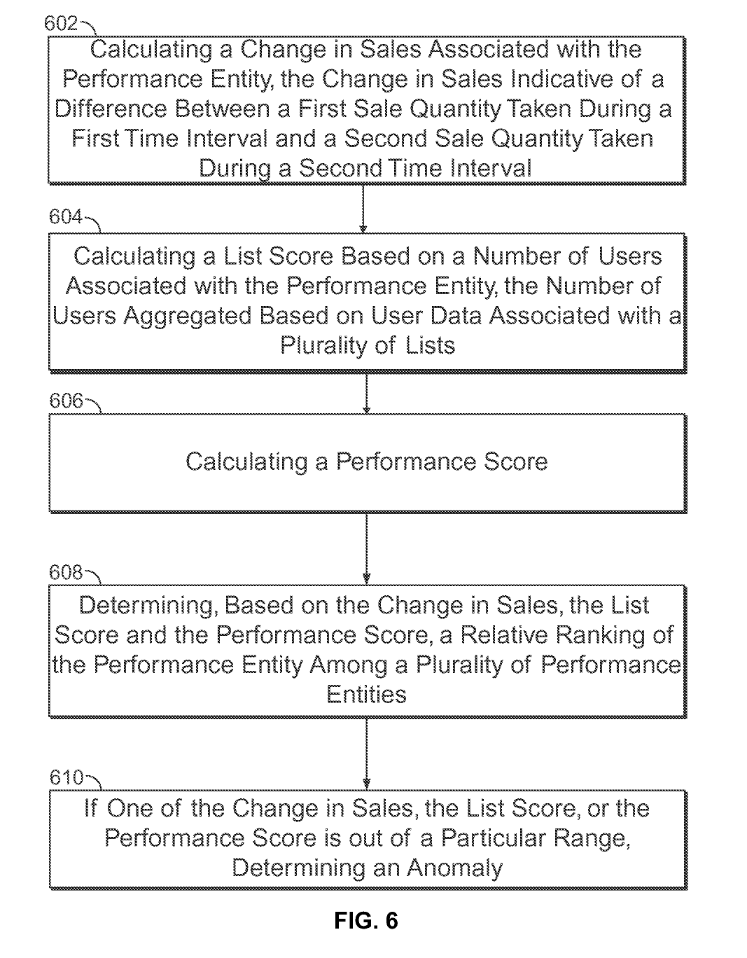

FIG. 6 is a flowchart of method of ranking a performance entity, in accordance with an embodiment. The term “performance entity” used herein applies to any entity including a band, a solo artist or musician, multiple artists or musicians, multiple bands, etc. The flowchart utilizes all categories of triangle 500 in order to determine the ranking. The steps in the flowchart may be performed by any hardware or software means. Server 102, web service 104, user device 106 or any combination of these devices may perform the steps of the flowchart.

Referring now to FIG. 6, at step 602, a change in sales, unique page views, and track listens associated with the performance entity are calculated. These changes are indicative of a difference between a first point quantity taken during a first time interval and a second point quantity taken during a second time interval. Server 102 calculates a change in point associated with the performance entity (e.g., a band or artist) where the change in point is indicative of a difference between a first point quantity taken during a first time interval and a second point quantity taken during a second time interval. In one embodiment, web service 104 provides band/artist data 406 to server 102. Server 102 may use the data associated with sales, views and listens to calculate a sales score and store data representing sales effort 310. Band/artist data 406 includes a first sale quantity (i.e., the number of albums, songs, merchandise etc. sold for the artist or band) taken during a first time interval (e.g., at week two) and a second sale quantity (i.e., the number of albums, songs, merchandise etc. sold for the artist or band) taken during a second time interval (e.g., at week one) or similarly a difference in unique page visits, or unique album/track listens. The difference between the two quantities may be determined and a change (% change or weekly change above expectation) is calculated for the performance entity for a given duration (e.g., one week). Weekly buys are calculated based on the number of albums sold by a specific artist each week. The total sales value for each week is divided by the average number of sales from inception and the result is a number yielding weekly performance, either on point, above or below average. Total sales is also divided by unique artist page views, which yields a conversion amount of how many people visiting the artist page actually purchase the record.

At step 604, a list score is calculated based on a number of users associated with the performance entity. The number of users are aggregated based on user data associated with a plurality of lists. Server 102 calculates a list score based on a number of users associated with the performance entity. The lists may be associated with a particular band/artist. In one embodiment, web service 104 provides band/artist data 406 to server 102. Band/artist data 406 includes data associated with multiple lists showing the number of users that are associated with the band/artist. In another embodiment, server 102 may obtain the data associated with multiple lists by other means. Server 102 may use the data associated with multiple lists to calculate a weighted average of a list score and store data representing mailing list effort 312, or may use the lists to create an average of weekly growth and score weekly points above, on par or below expectations. In one embodiment, server 102 may obtain raw data associated with multiple lists of users that are linked to a band/artist and may calculate a weighted average of the list score associated with the band/artist. The change may be accumulated over a period of time (e.g., a day, a week, a month, a year, etc.).

At step 606, a performance score is calculated. Server 102 calculates a performance score associated with the entity. The performance score may be associated with the band/artist. In one embodiment, web service 104 provides band/artist data 406 to server 102. Band/artist data 406 includes performance data. In another embodiment, server 102 may obtain the performance data by other means. Server 102 may use the performance data to calculate a performance score and store data representing performance effort 314. In one embodiment, server 102 may obtain raw data associated with a band/artist and may calculate a performance score associated with the band/artist. The performance score may be accumulated over a period of time (e.g., a day, a week, a month, a year, etc.).

At step 608, a relative ranking of the performance entity among a plurality of performance entities is determined based on the change in sales, the list score and the performance score. Server 102 determines a relative ranking of the entity among multiple entities. The relative entity is based on the change in sales, the list score and the performance score. Ranking calculation metric 306 (shown in FIG. 3) may use an algorithm in order to determine the relative ranking of the performance entity. Ranking calculation metric 306 uses the scores determined in steps 602-608 in order to determine the relative ranking. Ranking calculation metric 306 may utilize data representing sales effort 310, data representing mailing list effort 312, data representing performance effort 314, and/or data representing relationships 316 stored in memory 304 in server 102 in the algorithm used to determine the relative ranking of the entity. In another embodiment, the relative ranking may be determined external to server 102.

In step 610, if one of the changes in sales, the list score, or the performance score is out of a particular range, an anomaly is determined. Server 102 analyzes all of the criteria or categories of the triangle depicted in FIG. 5 in order to determine an anomaly. Each of the change in sales, the list score, or the performance score is analyzed against each other. Further each of the change in sales, the list score, or the performance score may be assigned a particular range based on the others. For example, if the change in sales amounts to $15,000 for an artist, the range of the performance score for the artist may be determined to be in the 50 to 75 range based on the change in sales (and/or on the weighted average of the change). The performance score may be determined based on past trends or calculations performed by server 102. However, suppose that the performance score yields 500 instead. Since the 500 is out of range of the 50 to 75, it can be determined that an anomaly exists. Further analysis of the artist data can be performed in order to determine what caused the anomaly. Thus, the anomaly is analyzed to determine whether the relative ranking is accurate. Additionally as weekly scores represent the sum of all three categories, a high score in one based on fraud with two other low categories will not be enough to significantly chart the artist above artists with lower scores in one category but more evenly dispersed scores overall. Additionally, as more artist information is gathered we can see commonalities among artists that also indicate anomalies. Supposed for 200 artists there exists a fairly similar ratio of album sales compared to mailing list size. We can use that ratio as a check on other artists whose numbers don't fall in that line and highlight possible manipulation.

In an embodiment, the sales include purchases associated with the performance entity made at one or more websites. The sales include purchases associated with the band/artist made at one or more websites that may be associated with one or more web services 104. Web service 104 may provide sales data to server 102. Band/artist data 406 includes a first sale quantity (i.e., the weighted average of a number of albums, songs, etc. sold for the artist or band) taken during a first time interval (e.g., at week two) and a second sale quantity (i.e., the weighted average of a number of albums, songs, merchandise etc. sold for the artist or band) taken during a second time interval (e.g., at week one). The difference between the two quantities may be determined and a list change is calculated for the performance entity for a given duration (e.g., one week).

In an embodiment, the calculating of the list score in step 604 of FIG. 6 further comprises calculating a weighted average of a list change associated with the performance entity. The list change indicates a difference between a first list quantity taken during a first time interval and a second list quantity taken during a second time interval. Server 102 may calculate a weighted average of a list change associated with the performance entity (e.g., a band or artist) where the list change is indicative of a difference between a first list quantity taken during a first time interval and a second list quantity taken during a second time interval. Details regarding calculation of the weighted average of a list change (or a weighted average of a mailing list) are described above with respect to FIG. 5. In one embodiment, web service 104 provides band/artist data 406 to server 102.

In an embodiment, step 606 of calculating a performance score for each band-artist, includes calculation of a change in performance score over a predetermined period of time (e.g., one week, month, quarter, or year). The performance score is calculated based on several factors, such as position of band-artist during each performance, size of a venue where band/artist performs, distance from band's/artist's hometown, etc. The listed factors used to calculate a performance score may be retrieved from one or more web services 104. Web service 104 may provide data associated with the listed factors to server 102 upon request or periodically. The difference between the values associated with the listed factors obtained during a first time period (e.g., first week) and a second time period predetermined time period (e.g., second week) may be determined and a performance score change is calculated for each band/artist for a given duration (e.g., one week, etc.).

In an embodiment, it is determined that the relative ranking is based on data associated with multiple entities. That is, the relative ranking is based on data associated with multiple bands/artists and that data is used as part of the ranking algorithm.

In an embodiment, calculating the amount of sales in step 602 of FIG. 6 is further based on an amount of sales accumulated at multiple websites. Suppose that server 102 is associated with or trusts web service 104-A and web service 104-B. Server 102 may use sales data generated at respective websites associated with each of the web services in order to calculate the amount of sales. In an embodiment, sales accumulated at one, two or more websites may be used (and weighted) in order to determine the amount of sales.

In an embodiment, the calculating a performance score in step 606 of FIG. 6 is based on at least one of: a show type, a position, a venue size, a radius, percentage of tickets sold, or history in the market.

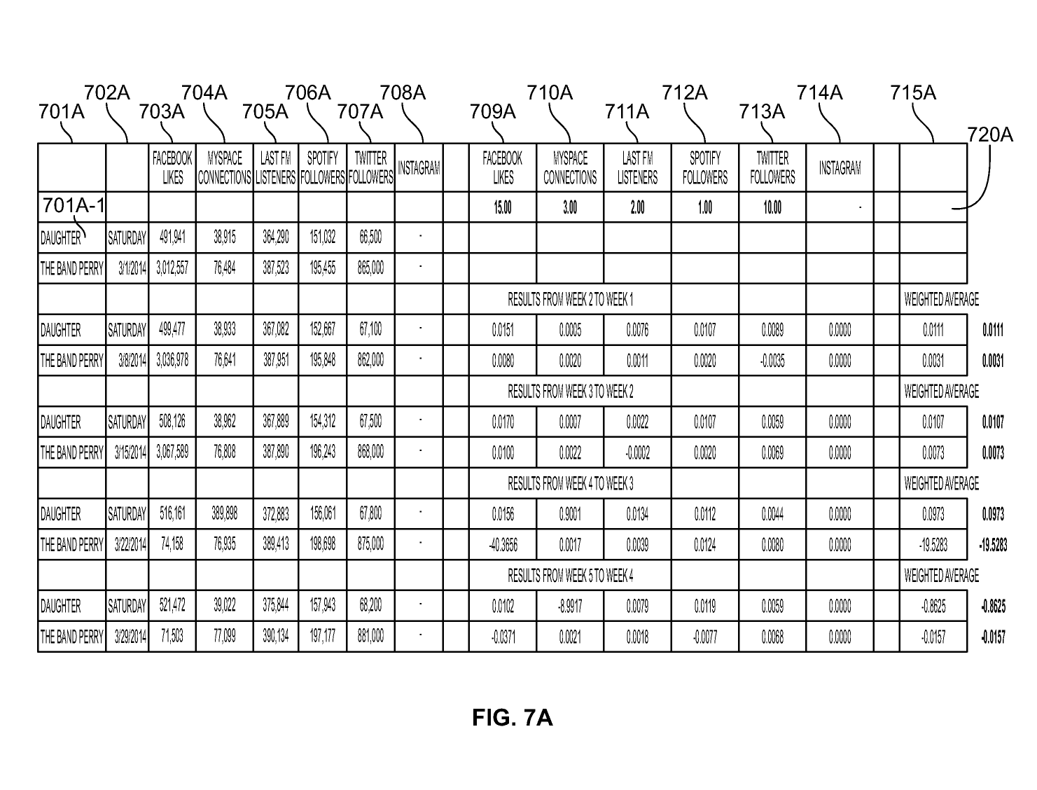

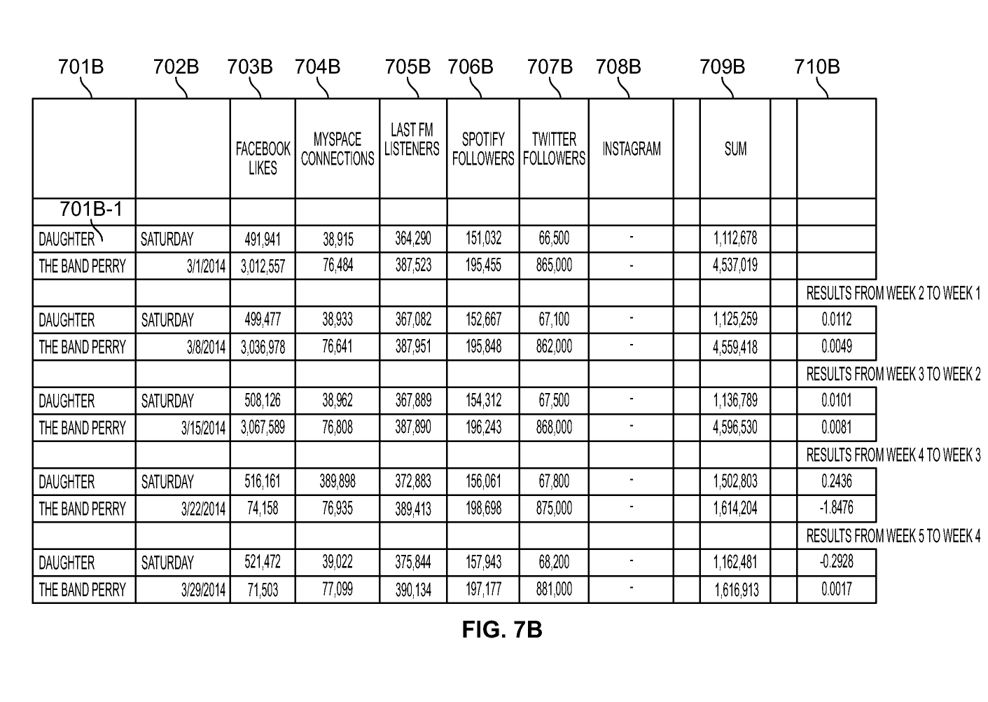

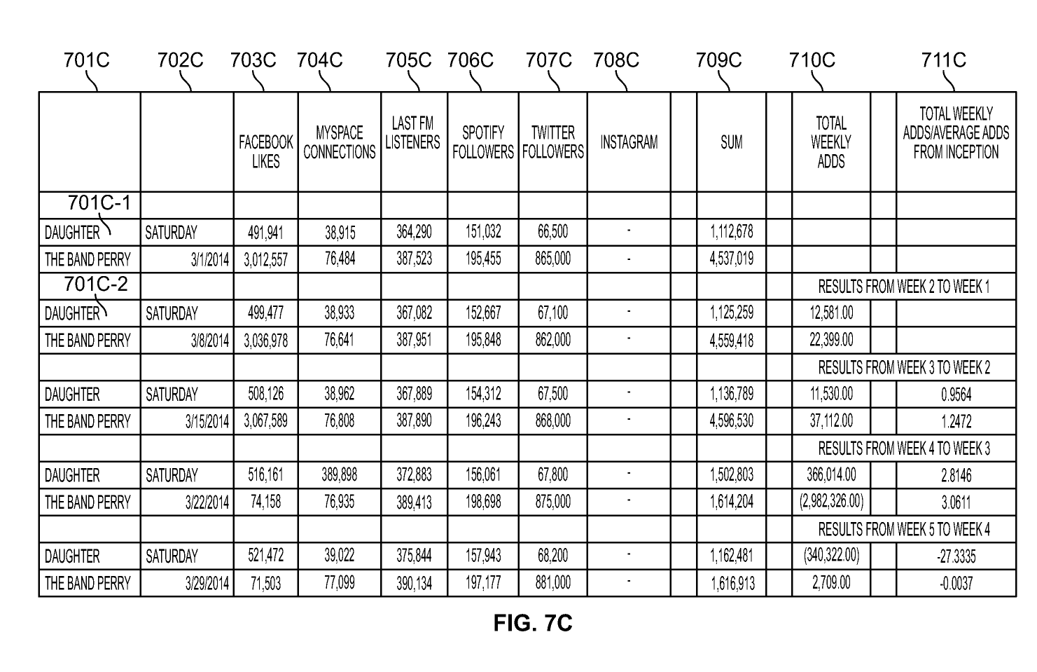

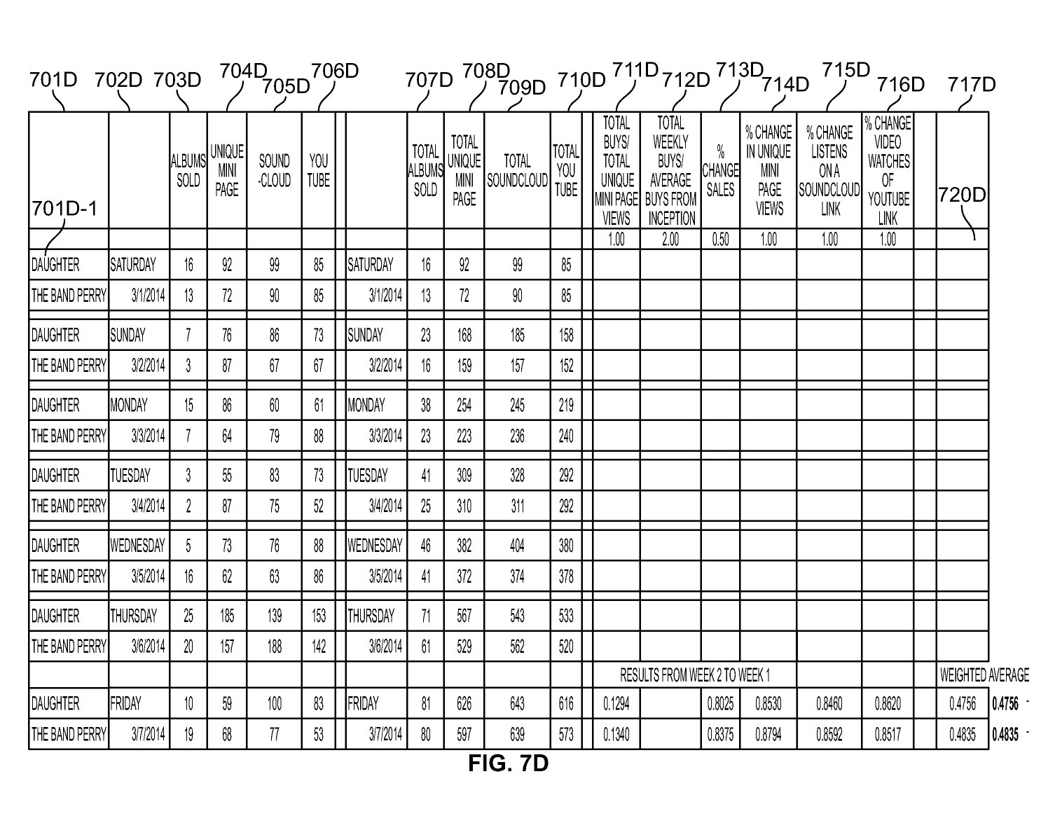

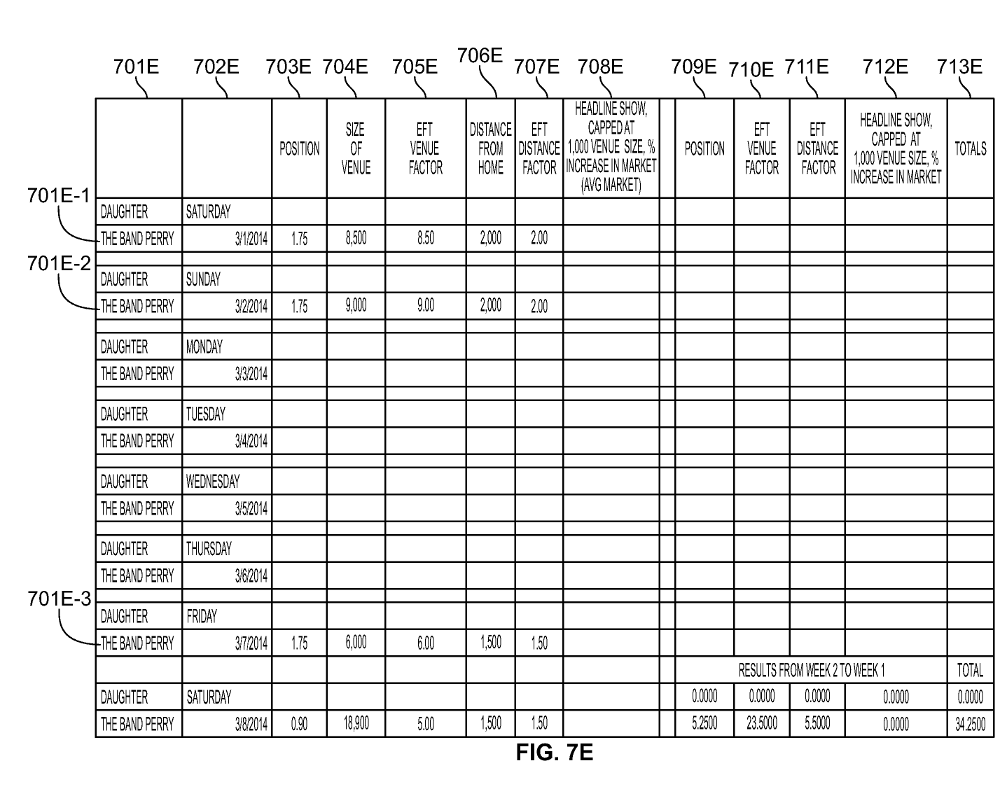

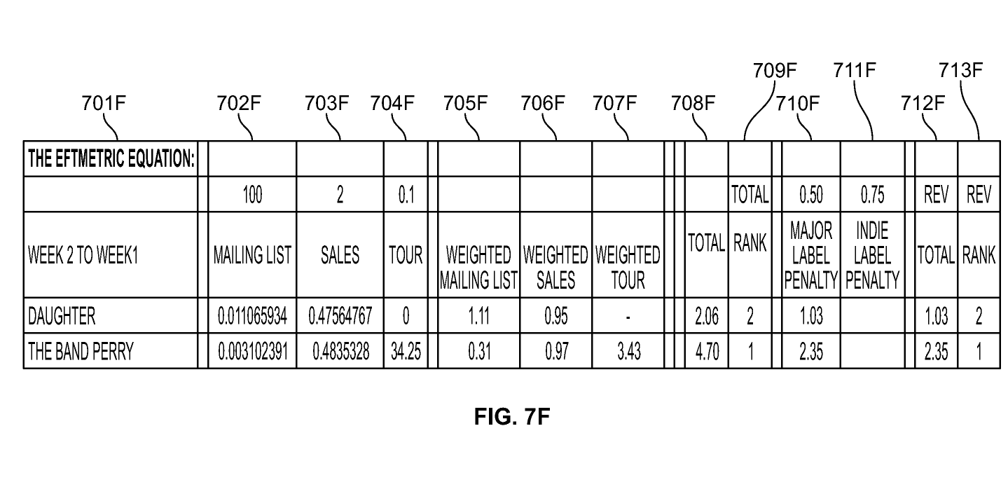

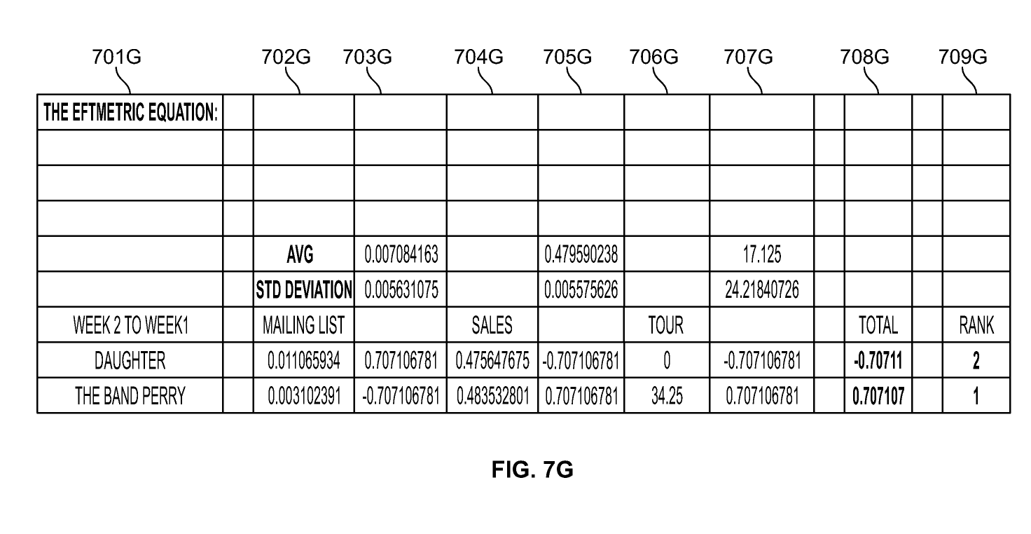

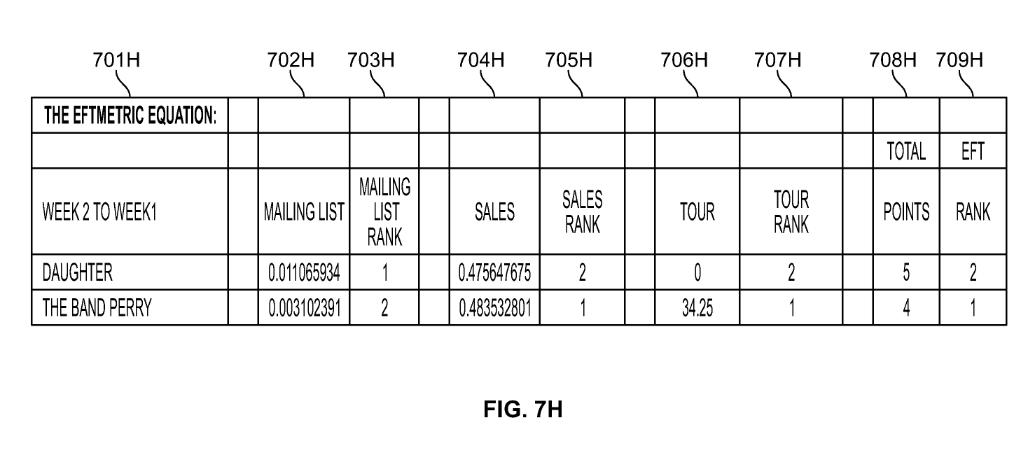

FIGS. 7A-7H provide exemplary charts illustrating the calculation of FIGS. 602-608 for various factors used to determine artists' overall rankings. Referring now to FIG. 7A, which depicts an exemplary chart reflecting calculation of (weighted averages) a change in a mailing list composed by artists' fans through a number of social media outlets for each artist. Field 701A of the chart lists all artists. Field 702A lists dates referencing time period during which weighted average of a change in mailing lists is calculated for each listed artist. Fields 703A-708A lists various social media outlets the users of which comprise a mailing list for each artist. Specifically, field 703A lists Facebook likes, field 704A lists MySpace connections, field 705A lists Last FM radio listeners, field 706A lists Spotify subscribers, field 707A lists a number of Twitter followers, and field 708A lists a number of Instagram users.

A subscriber mailing list for some social media outlets (e.g., Facebook, Twitter, Instagram) may be acquired by server 102 from web service 104-A and a subscriber mailing list for some other social media outlets (MySpace, Spotify, Last FM) may be acquired by server 102 from web service 104-B, in one embodiment. It is to be understood that subscriber lists indicate a number of users subscribed to an email listserv, users subscribed to a Short Message Service (SMS) messaging list, fans, friends, followers, listeners, connections or likes made on a social media website, or other lists.

It may be determined that a certain one social media outlet is a better indicator of the Mailing List category than certain other social media outlets and therefore, that certain one social media outlet may be assigned a higher weight than certain others social media outlets. Accordingly, in an embodiment, each social media outlet is assigned a corresponding weighting factor value to reflect the level of importance of each social media outlet in generating and expanding a mailing list. Row 720A lists a weighting factor value for each listed social media outlet. Specifically, the Facebook weighting factor value is 15. The MySpace weighting factor value is 3. The Last FM weighting factor value is 2. The Spotify weighting factor value is 1. The Twitter weighting factor value is 10. The Instagram weighting factor value is not set and, by default is zero. The calculated weighted average of a change in a mailing list for each artist is listed in field 715A.

To demonstrate a weekly calculation of the weighted average of a change in a mailing list, data relating to a single artist is analyzed. It is to be understood that calculation of the weighted average of a change in a mailing list for the remaining listed artist(s) is calculated in the same manner. For our calculations we recorded data from Saturday Mar. 1, 2014 at 12:00 AM through Friday Mar. 7, 2014 at 11:59 PM. The Friday ending value for the week recorded is the same as the Saturday starting value for the next week, so when we reference Saturday-Saturday, indicating a week of results we are in reality looking at data taken from 12:00 AM on a Saturday through the following Friday at 11:59 PM. On the initial date (Mar. 1, 2014) of a selected time period (Mar. 1, 2014-Mar. 8, 2014), the mailing list of the artist “Daughter” (701A-1) includes: 491,941 Facebook likes (703A); 38,915 MySpace connections (704A); 364,290 Last FM listeners (705A); 151,032 Spotify followers (706A); and 66,500 Twitter followers (707A). In this example, the mailing list for artist “Daughter” does not have a single Instagram follower (708A). Since there is no data available about the mailing list of artist “Daughter” prior to Mar. 1, 2014, weighted averages for each of the listed social media outlets is not calculated (fields 709A-714A are not assigned any value). Accordingly the total weighting average of a change in a mailing list for artist “Daughter” is not calculated. On the last day of the selected time period (i.e., Mar. 8, 2014), the system calculates the weighted average of a change in a mailing list for artist “Daughter” based on the data gathered during the selected time period. On Mar. 8, 2014, a week after recording of data relating to artist “Daughter” had begun, the mailing list of the artist “Daughter” (701A-1) is shown to be changed as follows: a number of Facebook likes (703A) grew to 499,477; a number of MySpace connections (704A) grew to 38,933; a number of Last FM listeners (705A) grew to 367,082; a number of Spotify followers (706A) grew to 152,667; and a number of Twitter followers (707A) grew to 67,100. There were no Instagram followers (708A) added to the mailing list for artist “Daughter”.

Upon receiving the mailing list data for each artist, the average of a mailing list change is calculated using the following formula:

PercentIncreaseMailingList1=(WeeklyMailingListChange)/(WeeklyTotalSubscribersFromInception) (E8)

Formula (E8) is used to calculate a percent increase of a mailing list change for the artist for each social media outlet. For example, for artist “Daughter”, a weekly mailing list change for the Facebook users was an increase by 7,536 subscribers (i.e., 499,477−491,941=7,536). Accordingly, the percent increase of the Facebook mailing list change for artist “Daughter” is approximately 0.0151 (i.e., (499,477−491,941)/499,477=0.01508). Formula (E8) is applied to calculate a weekly mailing list change for each social media outlet (e.g., MySpace, Last FM, Spotify, Twitter, and Instagram). FIG. 7A presents results of the described calculation as follows: a weekly mailing list change for the MySpace is 0.0005, a weekly mailing list change for Last FM 0.0076, a weekly mailing list change for Spotify is 0.0107, a weekly mailing list change for Twitter is 0.0089 and a weekly mailing list change for the Instagram is zero. Upon determining a weekly mailing list change for each social media outlet, a total weekly weighted average of a mailing list change is calculated for each artist. In the example of artist “Daughter”, the total weekly weighted average of a mailing list change is calculated using the following formula:

WeightedAverageMailingLists=aPercentIncreaseMailingList1)×(WeightingFactorValue1)+(PercentlncreaseMailingList2)×(WeightingFactorValue2)+ . . . +(PercentlncreaseMailingListN)×(WeightingFactorValueN))/(WeightingFactorValue1+WeightingFactorValue1+ . . . +WeightingFactorValueN) (E9)

As noted above, the weighting factor values are predetermined for each social media outlet, i.e., the Facebook weighting factor value is 15, the MySpace weighting factor value is 3, the Last FM weighting factor value is 2, the Spotify weighting factor value is 1, the Twitter weighting factor value is 10 and the Instagram weighting factor value is zero.

Accordingly, the WeightedAverageMailingLists (715A) for artist “Daughter” is determined as follows:

((0.015×15.00)+(0.0005×3.00)+(0.0076×2.00)+(0.0107×1.00)+(0.0089×10.0))/(15.00+3.00+2.00+1.00+10.0)=0.011061 . . . or 0.0111 when rounded to four decimal places.

The Weighted Average of Mailing Lists for the other artists is calculated in a similar manner as artist “Daughter”. A person skilled in the art will understand that value of the WeightedAverageMailingList may be scaled, rounded up, rounded down, or provided as a negative or positive value. Also, although not shown in FIG. 7A, Mailing List characteristics for each artist may also include calculations of the percentage increase in subscribers of each social media outlet for any given period of time (daily, weekly, monthly, quarterly, etc.).

FIG. 7B illustrates an alternative embodiment of determining (percent increases) a change in a mailing list composed by artists' fans through a number of social media outlets for each artist. Field 701B lists all participating artists. Field 702B lists dates referencing time period during which percent increases of a change in mailing lists is calculated for each listed artist. Fields 703B-708B lists various social media outlets the users of which subscribe to a mailing list for each artist. Specifically, field 703B lists Facebook likes, field 704B lists MySpace connections, field 705B lists Last FM radio listeners, field 706B lists Spotify followers, field 707B lists Twitter followers, and field 708B lists Instagram users. Field 709B contains a sum of mailing list subscribers for all social media outlets for each artist. Field 710B contains a value of percent increase of a mailing list change calculated for each artist for a specified (i.e., weekly) time period.

To demonstrate a weekly calculation of the percent increase of a change in a mailing list according to the alternative embodiment illustrated in FIG. 7B, data relating the same artist (“Daughter”) is analyzed. It is to be understood that the percent increase of a change in a mailing list for the remaining listed artist(s), according to the alternative embodiment, is calculated in the same manner.

On the initial date (Mar. 1, 2014) of a selected time period (i.e., Mar. 1, 2014—Mar. 8, 2014), the mailing list of the artist “Daughter” (701B-1) includes: 491,941 Facebook likes (703B); 38,915 MySpace connections (704B); 364,290 Last FM listeners (705B); 151,032 Spotify followers (706B); and 66,500 Twitter followers (707B). There were no Instagram followers (708B) added to the mailing list for artist “Daughter”. A total number of the mailing list subscribers for each artist is determined by simply calculating a sum of subscribers for all listed social media outlets. That is:

WeeklyTotalSubscribersFromInceptionForArtist=aWeeklyTotalSubscribersFromInception1)+(WeeklyTotalSubscribersFromInception2)+ . . . +(WeeklyTotalSubscribersFromInceptionN) (E10)

Accordingly, on Mar. 1, 2014 for artist “Daughter” the total number of the mailing list subscribers is: 491,941+38,915+364,290+151,032+66,500=1,112,678 subscribers.

On Mar. 8, 2014 it is determined that a number of subscribers for each social media outlet has changed as follows: a number of Facebook likes (703B) grew to 499,477; a number of MySpace connections (704B) grew to 38,933; a number of Last FM listeners (705B) grew to 367,082; a number of Spotify followers (706B) grew to 152,667; and a number of Twitter followers (707B) grew to 67,100. There were no Instagram followers (708B) added to the mailing list for artist “Daughter”. Accordingly, on Mar. 8, 2014 for artist “Daughter” the total number of the mailing list subscribers is: 499,477+38,933+367,082+152,667+67,100=1,125,259 subscribers.

Percent Increase of a change in a mailing list for an artist, according to the alternative embodiment, is calculated using the following formula:

PercentIncreaseMailingList1=(WeeklyMailingListChange)/(WeeklyTotalSubscribersFromInception) (E11)

For artist “Daughter”, percent increase of a change in a mailing list is calculated as follows:

(1,125,259-1,112,678)/1,125,259=0.01118 . . . or 0.0112 when rounded to four decimal places. Percent Increase of mailing lists for other artists is calculated in a similar manner as for artist “Daughter”. A person skilled in the art will understand that value of the PercentIncreaseMailingList1 may be scaled, rounded up, rounded down, or provided as a negative or positive value. Also, although not shown in FIG. 7B, Mailing List characteristics for each artist may also include calculations of the percentage increase in subscribers of each social media outlet for any given period of time (daily, weekly, monthly, quarterly, etc.).

FIG. 7C illustrates a third embodiment of determining (expectations) a change in a mailing list composed by artists' fans through a number of social media outlets for each artist. Field 701C lists all participating artists. Field 702C lists dates referencing time period during which expectations of a change in mailing lists is calculated for each listed artist. Fields 703C-708C lists various social media outlets the users of which subscribe to a mailing list for each artist. Specifically, field 703C lists Facebook likes, field 704C lists MySpace connections, field 705C lists Last FM radio listeners, field 706C lists Spotify followers, field 707C lists Twitter followers, and field 708C lists Instagram users. Field 709C contains a sum of mailing list subscribers for all social media outlets for each artist. Field 710C contains a value of a difference in a number of subscribers to a mailing list for each artist for a specified (i.e., weekly) time period. As in a previous embodiment, a total number of the mailing list of subscribers for each artist is determined by simply calculating a sum of subscribers for all listed social media outlets using formula (E10).

Field 711C contains a value of a current total/an average total of a difference in a number of subscribers to a mailing list for each artist for a specified (i.e., weekly) time period. A value of an expectation of a difference in a number of subscribers in a mailing list for a specified period of time is calculated using the following formula:

ExpectationFrominception=WeeklyChange/((WeeklyChange+PreviousChanges)/NumberOfTimePeriodsFromInception) (E12)

It is to be understood that fields 710C and 711C can contain positive values or negative values.

To demonstrate a weekly calculation of the expectation of a change in a mailing list according to the third embodiment illustrated in FIG. 7C, data relating the same artist (“Daughter”) is analyzed. It is to be understood that values of a difference in a number of subscribers to a mailing list and values of an average of a difference in a number of subscribers to a mailing list for each artist for a specified (i.e., weekly) time period, according to the third embodiment, is calculated in the same manner.

On the initial date (Mar. 1, 2014) of a selected time period (i.e., Mar. 1, 2014—Mar. 8, 2014), the mailing list of the artist “Daughter” (701C-1) includes: 491,941 Facebook likes (703C); 38,915 MySpace connections (704C); 364,290 Last FM listeners (705C); 151,032 Spotify followers (706C); and 66,500 Twitter followers (707C). There are no Instagram subscribers (708C) in the mailing list for artist “Daughter.” As in a previous embodiment, a total number of the mailing list of subscribers for each artist is determined by simply calculating a sum of subscribers for all listed social media outlets using formula (E10).

Accordingly, on Mar. 1, 2014 for artist “Daughter” the total number of the mailing list subscribers is: 491,941+38,915+364,290+151,032+66,500=1,112,678 subscribers.

On Mar. 8, 2014, the number of subscribers for each social media outlet has changed as follows: a number of Facebook likes (703C) grew to 499,477; a number of MySpace connections (704C) grew to 38,933; a number of Last FM listeners (705C) grew to 367,082; a number of Spotify followers (706C) grew to 152,667; and a number of Twitter followers (707C) grew to 67,100. There were no Instagram followers (708C) added to the mailing list for artist “Daughter”. Accordingly, on Mar. 8, 2014 for artist “Daughter” the total number of the mailing list subscribers (709C) is: 499,477+38,933+367,082+152,667+67,100=1,125,259 subscribers. A value of a difference in a number of subscribers in a mailing list for each artist for a specified (i.e., weekly) time period (710C) is a difference between a number of subscribers in a mailing list registered within the specified time period (i.e., a week). In our example, the value (710C) of a total weekly change in a number of subscribers in a mailing list for artist “Daughter” (700C-2) is 1,125,259—1,112,678=12,581 subscribers. A value of an average of a difference in a number of subscribers to a mailing list for each artist for a first week (Mar. 1, 2014 through Mar. 8, 2014) cannot be determined due to insufficient data (i.e., unknown PreviousChangeFromInception value).

On Mar. 15, 2014, the number of subscribers for each social media outlet has changed as follows: a number of Facebook likes (703C) grew to 508,126; a number of MySpace connections (704C) grew to 38,962; a number of Last FM listeners (705C) grew to 367,889; a number of Spotify followers (706C) grew to 154,312; and a number of Twitter followers (707C) grew to 67,500. There were no Instagram subscribers (708C) added to the mailing list for artist “Daughter”. Accordingly, on Mar. 15, 2014 for artist “Daughter” the total number of the mailing list subscribers (709C) increased to 1,136,789 subscribers (508,126+38,962+367,889+154,312+67,500=1,136,789). A value of a difference in a number of subscribers in a mailing list for each artist for a specified (Mar. 8, 2014 through Mar. 15, 2014) time period (710C) is a difference between a number of subscribers in a mailing list registered within the specified time period (i.e., a week). In our example, the value (710C) of a total weekly change in a number of subscribers in a mailing list for artist “Daughter” (701C-2) is 1,134,789—1,125,259=11,530 subscribers. A value of an expectation of a difference in a number of subscribers in a mailing list for each artist for a second week (Mar. 8, 2014 through Mar. 15, 2014) is calculated using formula (E12). Specifically, for artist “Daughter” a value of an expectation of a difference in a number of subscribers in a mailing list is: 11,530/((11,530+12,581)/2)=0.95644 . . . or 0.9564 when rounded to four decimal places. A person skilled in the art will understand that value of the ExpectationFromInception may be scaled, rounded up, or rounded down. Also, although not shown in FIG. 7C, Mailing List characteristics for each artist may also include calculations of the percentage increase in subscribers of each social media outlet for any given period of time (daily, weekly, monthly, quarterly, etc.).

The sales and the conversion of a number of people that visited an artist's site to hear a song and then decided to purchase the album are recorded. FIG. 7D illustrates sales and the conversion of a number of people that visited an artist's site to hear a song and then decided to purchase the album.

Field 701D lists all participating artists. Field 702D lists dates referencing time period during which purchases are tracked for each listed artist. Field 703D lists a number of albums sold for each artist daily. Fields 704D-706D list various websites and/or web files for each artist on which visitors can listen to a song/album. Specifically, field 704D lists a number of visits of an artist's personal page on a Unique Mini Page; field 705D lists a number of listens of an artist's song or album file on Soundcloud; field 706D lists a number of views of an artist's song or album file on YouTube. Field 707D contains a total number of albums sold for each artist since inception. Field 708D contains a total number of visits of an artist's personal page on a Unique Mini Page since inception; field 709D lists a number of listens of an artist's song or album on Soundcloud since inception; field 710D lists a number of views of an artist's song or album on YouTube since inception.

Field 711D contains a ratio of a total number of albums sold for each artist since inception versus a total number of visits of an artist's personal page on a Unique Mini Page since inception. Field 712D contains a ratio of a total number of weekly albums sold for each artist versus an average of a number of weekly albums sold for each artist since inception. Field 713D contains a value of a weekly percentage change in purchases for each artist. Field 714D contains a value of a weekly percentage change in a number of visits of an artist's personal page on Unique Mini Page. Field 715D contains a value of a weekly percentage change in a number of listens of an artist's song or album on Soundcloud. Field 716D contains a value of a weekly percentage change in a number of views of an artist's song or album on YouTube.

Calculations of values for each of Fields 711D-716D may be weighted based on significance of its characteristics. For example, in an embodiment, a ratio of a total number of albums sold for each artist since inception versus a total number of visits of an artist's personal page on Unique Mini Page since inception has a weight value of 1. A ratio of a total number of weekly albums sold for each artist versus an average of a number of weekly albums sold for each artist since inception has a weight value of 2. A percentage change in purchases for each artist has a weight value of 0.5. A percentage change in a number of visits of an artist's personal page on a Unique Mini Page has a weight value of 1. A percentage change in a number of listens of an artist's song or album on Soundcloud has a weight value of 1. A percentage change in a number of views of an artist's song or album on YouTube has a weight value of 1.

Sales data relating the same artist (“Daughter”) is analyzed to demonstrate a weekly calculation of the weighted average of a change in sales according to an embodiment illustrated in FIG. 7D. It is to be understood that sales data relating to others artists, according to an embodiment, is calculated in the same manner.

On the initial date (Mar. 1, 2014), artist “Daughter” (701D-1) sold 16 albums (703D). On the same day the system registered 92 visitors of the artist's personal page on the Unique Mini Page (704D), 99 listens of the artist's file on Soundcloud (705D), and 85 views of the artist's file on YouTube (706D). Since the acquired data is for initial day, the values for 707D-710D are identical to the values for 703D-706D.

While keeping track of daily sales for artist “Daughter,” seven days later, on Mar. 7, 2014, the system registered the following results: 81 albums sold since inception (707D), 626 visits of an artist's personal page on Unique Mini Page since inception (708D), 643 listens of an artist's file on Soundcloud since inception (709D), 616 views of an artist's file on YouTube since inception (710D).

Based on the received weekly results, the system calculates a ratio of a total number of albums sold for the artist since inception versus a total number of visits of an artist's personal page on Unique Mini Page since inception (711D), a ratio of a total number of weekly albums sold for the artist versus an average of a number of weekly albums sold for the artist since inception (712D), a value of a percentage change in purchases (713D), a value of a percentage change in a number of visits of an artist's personal page on Unique Mini Page (714D), a value of a percentage change in a number of listens of an artist's files on Soundcloud (715D), and a value of a percentage change in a number of views of an artist's file on YouTube (716D).

A formula to calculate a ratio of a total number of albums sold for the artist since inception versus a total number of visits of an artist's personal page on Unique Mini Page since inception is:

TotalBuysVTotalVisits=TotalBuysSincelnception/PageTotalVisitsSincelnception; (E13)

In the example of artist “Daughter”, the total number of albums sold since inception is 81. The total number of visits on Unique Mini Page since inception is 626. Accordingly, the ratio of a total number of albums sold since inception versus a total number of visits on Unique Mini Page since inception is 81/626=0.1294.

A ratio of a total number of weekly albums sold for an artist versus an average of a number of weekly albums sold for the artist since inception is not calculated for the first monitoring week, because the results will always be 1 as current week over a 1 week average is the same numerator over the same denominator for each artist. We need two weeks of data to arrive at that number.

A formula to calculate each of a value of a percentage change in purchases (713D), a value of a percentage change in a number of visits of an artist's personal page on Unique Mini Page (714D), a value of a percentage change in a number of listens of an artist's file on Soundcloud (715D), and a value of a percentage change in a number of views of an artist's file on (716D) is:

% Change=Total ValueWeeklyChange/TotalValueSinceInception; (E14)

In the example of artist “Daughter”, in an embodiment presented in FIG. 7D, the percentage change in purchases (713D) is (81−16)/81=0.80246 . . . or 0.8025 is rounded up to four decimal places; the percentage change in a number of visits of an artist's personal page on Unique Mini Page (714D) is (626−92)/626=0.8530; the percentage change in a number of listens of an artist's file on Soundcloud (715D) is (643−99)/643=0.8460; and the percentage change in a number of views of an artist's file on YouTube (716D) is (616−85)/616=0.8620.

Upon determining each of a value of a ratio of a total number of albums sold for the artist since inception versus a total number of visits of an artist's personal page on Unique Mini Page since inception (711D), a ratio of a total number of weekly albums sold for the artist versus an average of a number of weekly albums sold for the artist since inception (712D), a percentage change in purchases (713D), a value of a percentage change in a number of visits of an artist's personal page on Unique Mini Page (714D), a value of a percentage change in a number of listens of an artist's file on Soundcloud (715D), and a value of a percentage change in a number of views of an artist's file on YouTube (716D), a weighted average of a change in sales is calculated as:

WeightedAverageSales=(TotalSalesFromInception1/Unique MiniPageViewsFromInception)×(WeightingFactorValue1)+(WeeklyTotalSales/AverageWeeklyTotalSales)×(WeightingFactorValue2)+(% ChangeSales)×(WeightingFactorValue3)+(% ChangeUniqueMiniPageViews)×(WeightingFactorValue4)+(% ChangeListens)×(WeightingFactorValue5)+(% Change Video Views)×(WeightingFactorValue6)/(WeightingFactorValue1+WeightingFactorValue2+WeightingFactorValue3+WeightingFactorValue4+WeightingFactorValue5+WeightingFactorValue6) (E15)

In the example of artist “Daughter”, the total sales average is ((0.1294×1.0)+(0×2.0)+(0.8025×0.5)+(0.8530×1.0)+(0.8460×1.0)+(0.8620×1.0))/(1.0+2.0+0.5+1.0+1.0+1.0)=0.47563 . . . or 0.4756 when rounded to four decimal places. A person skilled in the art will understand that value of the WeightedAverageSales may be scaled, rounded up, or rounded down. Also, although not shown in FIG. 7D, Sales characteristics for each artist may also include calculations of the percentage increase for any given period of time (daily, weekly, monthly, quarterly, etc.).

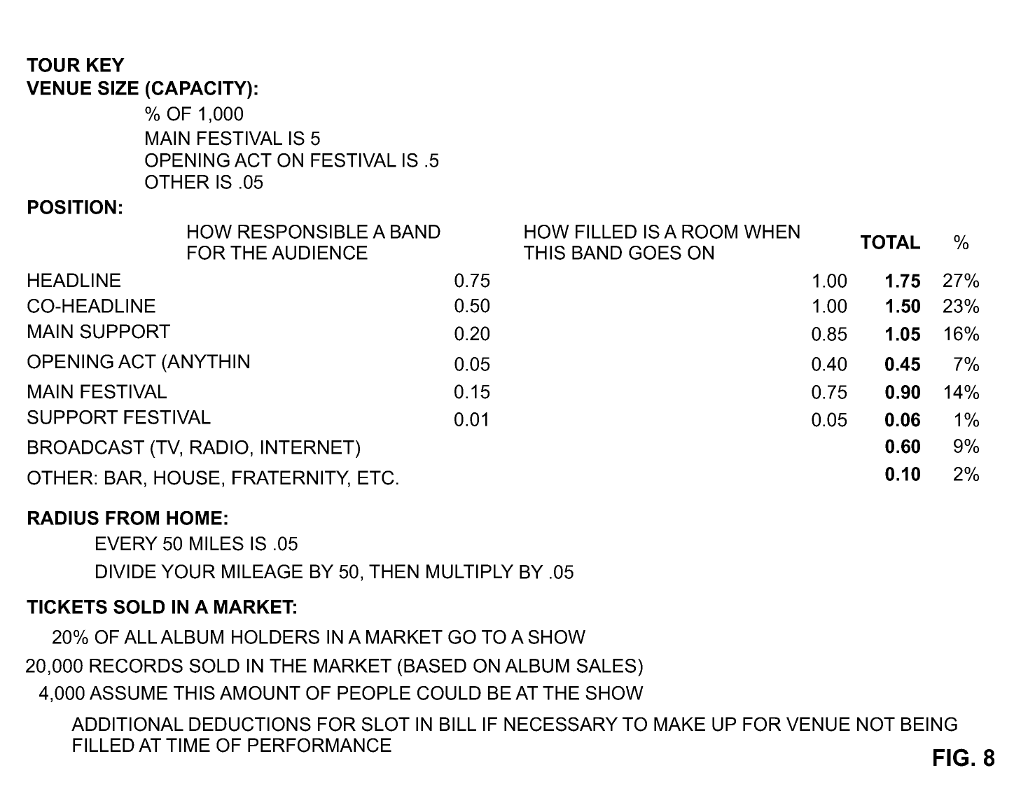

FIG. 7E illustrates an embodiment of determining a tour performance score for each artist for a predetermined time period. Field 701E lists all participating artists. Field 702E lists dates corresponding to a time period during which weighted average of a change in mailing lists and sales is calculated for each listed artist. Field 703E lists an artist's position in a show. The position may be calculated based on the artist placement in the show, whether they open the show and perform for less people or whether they headline the show and perform to the most people. FIG. 8 illustrates an exemplary key values used to determine a position value for each artist with respect to the artist's position in the show (e.g., headliner, co-headliner, main support, opening act) and type of the show (e.g., main festival, support festival, media broadcast, small event performance).

Field 704E illustrates a venue size where an artist performs. A “Venue Size” quantifies a performance made by a band/artist based on the size of the venue. In an embodiment, the larger the venue size, the higher the score assigned. The Venue Size may include an accumulated quantified score of all show venues performed by a band over a period of time (e.g., spanning a week, a month, etc.).

Field 705E illustrates a venue factor indicative of the venue size value determined in 704E per 1,000 visitors. Field 706E illustrates a distance in miles between a venue location and an artist's home. Field 707E illustrates a distance factor value indicative of the distance between venue location and artist's home determined in 704E per 50 miles times 0.05 or 1,000 miles. We have the option of keeping this denominator constant for all artists or changing it for each artist based on where they live. For example, we may find it better to use a base of 25 miles for artists that live in the Northwest since there are much fewer areas to play and each one is separated by longer distances. Field 708E illustrates an artist playing a headline show in a returning market. This is the idea that when an artist headlines a show in a market, those headline numbers should grow over time. Thus, an artist picks up fans with each performance and maintains most of them for future performances in a specific area. The ability to cap the audience provides a reward for smaller acts who work hard to grow their audience over time, who can't compete against large acts that get more points for venue size. Large acts plateau over time in terms of audience so this is a way to help push new acts which grow in markets.

In an embodiment, tour-related metrics are recorded daily and the tour performance is determined and summarized over a predetermined period of time (week, month, quarter, year, etc.). To demonstrate a weekly calculation of a tour performance for an artist according to an embodiment illustrated in FIG. 7E, data relating to artist “The Band Perry” is analyzed. It is to be understood that the tour performance for all listed artists is calculated in the same manner.

On the initial date (Saturday, Mar. 1, 2014) of a selected time period (i.e., Mar. 1, 2014—Mar. 8, 2014), artist “The Band Perry” is shown to perform a show as a headliner (position of artist “The Band Perry” (701E-1) is 1.75 which, in accordance with the exemplary key provided in FIG. 8, means that artist “The Band Perry” is a headliner and as such is responsible for an audience and for how filled a venue when artist “The Band Perry” appears on stage). The size of the venue is 8,500 seats. It is to be understood that a number of seats may be calculated to include seating capacity only, standing room only, or a combined number of seating and standing room. In accordance with the exemplary key provided in FIG. 8, the venue factor value is 8.50. The venue where artist “The Band Perry” performed on Mar. 1, 2014 is located 2,000 miles away from the home of artist “The Band Perry”. The distance factor value, in accordance with the exemplary key provided in FIG. 8, is 2.0.

On Sunday, Mar. 2, 2014, artist “The Band Perry” had a second show in which artist “The Band Perry” was also a headliner (position of artist “The Band Perry” (701E-2) is 1.75). The size of a second venue is 9,000 seats so Venue factor is set to be 9.0. The second venue is also located 2,000 miles away from the home of artist “The Band Perry”. Distance factor is set to be 2.00. There is no performance data recorded for artist “The Band Perry” Monday, Mar. 3, 2014 through Thursday, Mar. 6, 2014, i.e., artist “The Band Perry” did not perform in a show Monday, Mar. 3, 2014 through Thursday, Mar. 6, 2014.

On Friday, Mar. 7, 2014 artist “The Band Perry” had a third show in which artist “The Band Perry” was a headliner (position of artist “The Band Perry” (701E-3) is 1.75). The size of a second venue is 6,000 seats. Venue factor is set to be 6.00. The second venue is located 1,500 miles away from home of the artist “The Band Perry”. Distance factor is set to be 1.50.

Data for Saturday, Mar. 8, 2014 is not included in calculation for this time period as data for Mar. 8, 2014 is to be included in the calculations for the following time period. Based on the recorded data of performance effort by artist “The Band Perry”, total values of position, venue factor and distance factor are calculated. According to an embodiment, each of the total value of position, venue factor and distance factor is a sum of corresponding values. For example, the total position value for artist “The Band Perry” for Mar. 1, 2014 through Mar. 8, 2014 is a sum of position values for each recorded day: 1.75+1.75+0+0+0+0+1.75=5.25.

Similarly, a total value of venue factor is calculated as a sum of venue factor values for the recorded time period: 8.50+9.00+0+0+0+0+6.00=23.50. A total value of distance factor is calculated as a sum of distance factor values for the recorded time period: 2.00+2.00+0+0+0+0+1.50=5.50. According to an embodiment, a value of a total tour performance effort is calculated as a sum of the total position value, the total venue factor value, and the total distance factor value. For artist “The Band Perry” the total tour performance effort value is 5.25+23.50+5.50=34.25. Because “The Band Perry” did not headline a show in a returning market under a 1,000 person capacity there are no values for 708E.

FIG. 7F illustrates a first embodiment of a calculation of a total calculated score for a mailing list, sales, and tour performance for each artist for a predetermined time period. FIG. 7F also illustrates the use of weightings to calculate overall rankings of all listed artists for a predetermined time period. To demonstrate a calculation of the total weighted calculated score of mailing list, sales, tour performance, and overall ranking for each artist for the time period of Mar. 1, 2014 through Mar. 8, 2014, data relating the artists “Daughter” and “The Band Perry” is analyzed. It is to be understood that values of calculation of the total calculated score of mailing list, sales, tour performance, and overall ranking for each artist for a predetermined time period, according to an embodiment of FIG. 7F, is calculated in the same manner.

The data for Mailing List, Sales, and Tour performance for each illustrated artist (i.e., “Daughter” and “The Band Perry”) used to calculate the overall ranking for the time period in question were determined in an embodiment illustrated in FIGS. 7A-7E. Accordingly, the total weighted average of Mailing List subscribers (702F) was determined as presented in FIGS. 7A-7C. The total sales score (703F) was determined as presented in FIG. 7D, and the total tour performance effort value (704F) was determined as presented in FIG. 7E. In the presented example, using FIG. 7A the total weighted average of Mailing List subscribers for artists “Daughter” and “The Band Perry” is 0.011 and 0.003, respectively. The total sales score is 0.47 and 0.48, respectively. The total tour performance effort value is zero for artist “Daughter” and 34.25 for artist “The Band Perry.” Since it is more valuable to even out mailing list growth in comparison with maintaining sales growth and the tour performance, weighting factors are assigned to each listed category. In the example illustrated in FIG. 7F, the Mailing list metric is assigned a weighting factor value of 100.00, the Sales effort is assigned a weighting factor of 2.00. The tour performance metric is assigned a weighting factor of 0.10. Fields 705F-707F contain the values of the Mailing List, Sales, and Tour Performance effort weighted by the weighting factors assigned to the corresponding fields. That is, for artist “Daughter” field 705F contains a weighted value for the Mailing List (1.11=0.011×100); field 706F contains a weighted value for the Sales (0.95=0.47×2); field 707F contains a weighted value for the Tour Performance effort—zero, because artist “Daughter” did not perform in any show on Mar. 1, 2014 through Mar. 8, 2014. For artist “The Band Perry” field 705F contains a weighted value for the Mailing List (0.31=0.0031×100); field 706F contains a weighted value for the Sales (0.97=0.48×2); field 707F contains a weighted value for the Tour Performance effort (3.43=34.25×0.1). Based on the calculated values a total weighted value is calculated for each artist. For example, for artist “Daughter”, the total weighted value is a sum of the weighted values listed in fields 705F-707F: 1.11+0.95+0=2.06. For artist “The Band Perry”, the total weighted value is 0.31+0.97+3.43=4.70. According to the embodiment illustrated in FIG. 7F, the total overall ranking of the artists is determined in direct correlation with the total weighted value. Accordingly, artist “The Band Perry” is ranked higher than artist “Daughter” based on the metrics recorded and values calculated during the week of Mar. 1, 2014 through Mar. 8, 2014.

As noted earlier, the disclosed method and system is meant to level the playing field among the participating artists, some of whom may have a major label and/or indie label contracts. In order to equalize the chances among the artists, penalty points are assessed to those artists who are signed to major label and/or indie labels. Points are arbitrary and chosen at our discretion. According to an embodiment illustrated in FIG. 7F, the total weighted value for an artist having a major label contract is reduced by 50% (penalty factor value is 0.5), the total weighted value for an artist having an Indie label contract is reduced by 25% (penalty factor value is 0.75) In the example illustrated in FIG. 7F, both “Daughter” and “The Band Perry” have a major label contracts. Accordingly, the respective total weighted value for “Daughter” and for “The Band Perry” is reduced by 50% to be 1.03 and 2.35, respectively. The ranking of “Daughter” and “The Band Perry” relative to each other are not changed; however, the overall ranking for both artists is affected. Although an artist may once be on an indie label and has now moved up to a major, we must use their current label status to determine the penalties. In other words, we use whichever label is currently putting extra marketing dollars behind the act, because that is the direct benefit an unsigned artist won't have, so we penalize accordingly.

FIG. 7G illustrates a second embodiment of a calculation of a total calculated score for a mailing list, sales, and tour performance for each artist for a predetermined time period.

The calculated score data for Mailing List, Sales, and Tour performance for each illustrated artist were determined in an embodiment illustrated in FIGS. 7A-7E. Accordingly, the total weighted average of Mailing List subscribers (702G) was determined as presented in FIGS. 7A-7C. The total sales score (704G) was determined as presented in FIG. 7D, and the total tour performance effort value (706G) was determined as presented in FIG. 7E.

According to the second embodiment illustrated in FIG. 7G, the calculated score values for each of the mailing list, sales, and tour performance effort is calculated using the following formula:

Total Weighted ValueMailingList1=((Weighted ValueMailingList1−Average ValueAllLists)/STDDevValueAllLists); (E16)

Total Weighted ValueSalesList1=((Weighted ValueSalesList1−Average ValueAllLists)/STDDevValueAllLists); (E17)

TotalWeightedValueTourList1=((WeightedValueTourList1−Average ValueAllLists)/STDDevValueAllLists); (E18)

Upon calculating the calculated score values for each of the mailing list, sales, and tour performance effort for all listed artists, a combined total normalized value for each artist is calculated by adding the standardized values for each of the mailing list, sales, and tour performance effort for each artist:

TotalNormalizedValueList1=TotalNormalizedValueMailingList1+TotalNormalizedValueSalesList1+TotalNormalizedValueTourList1; (E19)

It is to be understood that values of calculation of the total scores of mailing list, sales, tour performance, and overall ranking for each artist for a predetermined time period, according to an embodiment of FIG. 7G, is calculated in the same manner. The Mean or Average for all artists is calculated (for the weekly results) for Mailing List, Sales and Performance yielding scores of 0.007, 0.480 and 17.13 respectively. The Standard Deviation for all artists is calculated (for the weekly results) for Mailing List, Sales and Performance yielding scores of 0.005, 0.005 and 24.22 respectively. As was determined earlier, for artist “Daughter” a weighted average value for mailing list is 0.011, a sales score is 0.47, and a value for tour performance is 0. Taking into account the recorded results for the Mean and Standard Deviation for all artists for the week, for artist “Daughter” the standardized value for Mailing List is 0.71, the standardized value for Sales is −0.71 and the standardized value for Performance is −0.71. The standardized sum of Mailing List, Sales, and Tour Performance rankings for artist “Daughter” is (0.71)+(−0.71)+(−0.71)=−0.71. For artist “The Band Perry” a weighted average value for mailing list is 0.003, a sales score is 0.484, and a value for tour performance is 34.25. Taking into account the recorded results for the Mean and Standard Deviation for all artists for the week, for artist “The Band Perry” the standardized value for Mailing List is −0.71, the standardized value for Sales is 0.71 and the standardized value for Performance is 0.71. The standardized sum of Mailing List, Sales, and Tour Performance rankings for artist “The Band Perry” is (−0.71)+(0.71)+(0.71)=0.71;

A combined total weighted value for each artist is directly correlated to determine the overall ranking for each artist. In our example, the ranking of “The Band Perry” yields the number 1 position (0.71) and “Daughter” results in the number 2 position (−0.71).

FIG. 7H illustrates a third embodiment of calculating overall rankings among listed artists. In the third embodiment, ranking for each of the categories (e.g., Mailing List, Sales, Tour Performance) is calculated based on the values calculated for each artist according to embodiments illustrated in FIGS. 7A-7E. Upon determining the ranking of each artist in each listed category, an overall ranking for each artist is determined as a sum of each category's rankings for each artist. To illustrate the determination of an overall ranking of the artists, data relating the artists “Daughter” and “The Band Perry” is analyzed. It is to be understood that values of the calculation of the total scores for mailing list, sales, tour performance, an overall ranking for each artist for a predetermined time period, according to an embodiment of FIG. 7H, is calculated in the same manner.

As was determined earlier, for artist “Daughter” a weighted average value for mailing list is 0.011, a sales score is 0.47, and a value for tour performance is 0. The weighted average value of 0.011 for Mailing List ranks artist “Daughter” as 1^{st} in the Mailing List ranking. The value of 0.47 in sales ranks artist “Daughter” as 2^{nd} in the Sales ranking out of the same group of artists. The value of zero in Tour Performance ranks artist “Daughter” as 2^{nd} in the Tour Performance ranking. The sum of Mailing List, Sales, and Tour Performance rankings for artist “Daughter” is 1+2+2=5;

For artist “The Band Perry” a weighted average value for mailing list is 0.003, a sales score is 0.48, and a value for tour performance is 34.25. The weighted average value of 0.003 for Mailing List ranks artist “The Band Perry” as 2^{nd} in the Mailing List ranking. The value of 0.48 in sales ranks artist “The Band Perry” as 1^{st} in the Sales ranking out of the same group of artists. The value of 34.25 in Tour Performance ranks artist “The Band Perry” as 1^{St} in the Tour Performance ranking. The sum of Mailing List, Sales, and Tour Performance rankings for artist “The Band Perry” is 2+1+1=4. The lowest combined value of the rankings results in the highest overall ranking among all listed artist (709H). In the illustrated example, the combined value of the rankings for artist “The Band Perry” is lower than the combined value of the rankings for artist “Daughter”, accordingly, the overall ranking of artist “The Band Perry” is higher than the overall ranking of artist “Daughter.”

It is to be understood that additional fields and rows may be provided in FIGS. 7A-7H. For example, Sales may include a total buys from inception/listens sub-field. Moreover, Field 714D could contain a ratio of weekly visits of an artist's personal page on their Unique Mini Page over the average weekly number of visits from inception. Field 715D could contain a ratio of weekly visits of an artist's personal page on Soundcloud over the average number of visits from inception. Field 716D could contain a ratio of weekly watchers of an artist's YouTube link over the average number of watchers from inception. These measurements of weekly performance above expectation would favor older more established artists as opposed to newer acts who are better served with % increases based on their current size, since that measurement rewards consistency over growth. Additionally, these equations could be added to the % increases as found in our example, as opposed to either/or. In an embodiment, no sales may be associated with the listens field. For example, the listens may refer to free streaming or downloaded songs acquired by a customer for a particular band/artist. In another embodiment, the listens may include songs that are sold for money. Field 708E could contain a ratio of current headline show capacity numbers in a particular market over the average capacity in that market from inception. Similar to the above-mentioned sales fields, using a score above expectation here would reward the more established acts versus the newer artists who have an easier time growing their audience. Again, that field could replace or be added to the % increase in headline show capacity in our example. We could also add a field for percent of tickets sold whereby we would take the number of tickets sold for a show and divide that by the number of possible seats available for sale (capacity). We could also add a field of merchandise per head by taking the amount of merchandise sold for a show and dividing it by the number of tickets sold or people in attendance (which would include comp tickets). The exact tickets sold and merchandise sold numbers would only be used if we obtain correct data from reliable third party sources, and not leave this information up to the artist as that may lead to falsifying numbers. The information contained in chart 700 may be based on raw data acquired from websites/sources. That is, a website may provide daily data relating to sales, for example. In order to determine “Current Buys/Listens” metric, daily data may be accumulated for a period of time in order to determine a quantity that is expressed in FIGS. 7A-7H.

In an embodiment, a number may be assigned to every artist based on a combination of factors used to quantify and establish a position in the ranking system. In one embodiment, these numbers may be presented in two ways: the weekly highest score, and the weekly highest positive movements. In one embodiment, charts serve to highlight artists that are putting forth the maximum effort to build their career. The charts also serve to expose artists to the public without the traditional uses of TV, radio and retail.

In one embodiment, the algorithm for determining the rank of every band/artist starts at 0. The “age” of the band/artist is not taken into consideration. For example, it does not matter if an artist has been around 20 years or just starting. What is observed is how the artist will progress from the current moment into the future. Weekly growth is quantified across multiple platforms and the ranking system determines how it all connects. Weights may be set on every category (and sub-category including an individual website), which can be modified allowing the ranking system to adjust scores when relevance changes. The relationships between each category is observed and analyzed as well as the logical way they interact and influence each other, eliminating most manipulation. In an embodiment, this provides a hybrid mix of Internet and street data, a combination of old and new—grassroots marketing, elbow grease and social media. The cultivation of a fanbase is measured in this way as opposed to the singular actions of a fan.

For the artist, the ranking system allows him/her to grow his/her career. The artist can do whatever it takes to cover the most ground in order to increase popularity. For example, the artist can play every show he/she can, engage his/her fans in any way possible, over every medium possible, and work to hone his/her craft and produce quality music. The more the artist does, the higher he/she charts, the more he/she get exposed.

For the consumer, the ranking system provides a filtered list of the hardest working artists based on their ranks. Although charting is based on effort, artists cannot go far without a quality product. Fans will not be retained without proper engagement. Poor sounding recordings will most likely not be purchased. Poor live performances will lead to bad reviews which will lead to drops in ticket sales and un-subscribers to the mailing list. The combination of these factors will cause an artist's overall rank to drop and reduce their visibility. The ranking system does not identify anyone as better than another. Rather, those artists that are most deserving of a consumer's attention are identified and ranked accordingly.

By using the ranking system described above, artists can be truly record label free. Artists since the beginning of time had the ability to record and sell their own music in some fashion, but the ability to break through has often eluded them. Even with the advent of the Internet, social media, and online retail, artists have generally failed to capture critical mass without a label. The ranking system puts an end to this by replacing the majority of functions a label does or did at minimal cost to an artist. Because it uniquely positions artists, the ranking system validates the credibility of the artists. By using the ranking systems, artists can now overcome obstacles imposed by existing systems described as follows.

Traditionally, label produced music meant the label controlled the studio time, production, manufacturing, etc. In this day and age, physical copies of music may not be needed but music/albums still need to be recorded. The advent of digital technology and services has enabled artists to make quality records in small studios or at home, without help from a label. The ranking system does not base the rankings on just the quality of songs but also on the quality of their recorded product. This means that an artist with a quality written album recorded on a budget can compete against an expensive recording with high-end production. Here the charting is based on the consumer. The ranking system is based more on quality control. Consumers favor a good quality album and exposure for good quality artists will continue to grow.

Another function of the label was to get an artist's music into stores. Distribution nowadays is more digital than physical, but the concept is the same. However, since other sites, be they Internet retailers or Internet subscription sites fail to have a compelling way for a new artist to cut through the clutter and be seen and heard, the need for an artist to sell their music on many platforms becomes meaningless. The ranking system creates exposure and allows the artist to sell their music on one site, whichever site runs or is associated with the ranking system. The ability to effectively sell music means ownership of the product can remain with the artist, and multi-album long term label deals are eliminated.

Labels used to deliver artists to television networks, leveraging their rosters, their income, or their rights to get their artists heavy rotation on music television. Since these networks barely show music videos anymore, the idea of labels getting their artists on TV is less and less a reality. Online video services allow videos to be played and seen by anyone, so an artist can produce videos inexpensively, similarly to the way they currently produce albums. The ranking system can be used to program video rotation. In other words, the ranking system can be used with an audio/video player and the order in which artists are seen on the player can be based on the weekly chart positions. Moreover, the players can be programmed to rotate videos giving more showings to the artists with higher ranked scores. An artist in the top 5 might get 4 plays a day, while an artist in the bottom 5 gets 1. Once again, visibility is in the hands of the artist and their programming is not necessarily based on label dollars or leverage.

Radio can be programmed the same as video, using the ranking system's ranked position to determine plays or rotation. An Internet player can be created using the ranking system and allowing artists to have radio visibility based on their metric scores. Traditional radio exposure has been based on labels buying time through the use of independents. Now time can be earned, not purchased.

One of the other functions of the label was to support an artist until they were ready to properly record and tour. Those days are over. Since labels have so little room for error they are signing what in their mind are fully developed, sure-thing artists. That means labels may no longer invest significant money into smaller acts, provide them with resources, and allow them to grow over a few albums. The ranking system cultivates this type of artist development. The ranking system's design works in the way an artist's development works. Charting growth and watching change, over all mediums, over time, ensures artists are hitting every step on their way to progress, retaining the most fans in the process. By using the triangle in the ranking system, artists can be informed where they need improvement. They can be directed to run more Internet campaigns, focus on driving new faces to their website, or to get on the road and perform more (headline) shows. Additionally they can look at the data to make decisions regarding touring in certain areas, during certain periods of seasonality, future career planning or phases of the album cycle based on their ranking calculation. The ranking system monitors and tracks the necessary elements of proper artist development, so growth can be fostered the way traditional labels once did.

Other music metrics provide data for labels and artists, but not much for the consumer. In turn their results are geared towards marketing campaigns in conjunction with sponsors or the manager/agent looking to make decisions. These companies may not be selling records directly, and their results so far have not caused many breakthroughs for new artists in the music business, since they track easily manipulated data led by an overly vocal minority subsection of a fanbase. The few sites that do share some artist statistical information with consumers highlight data living on their particular website. This narrow data may give an artist visibility on that website but since they fail to account for the majority of work an artist does on the internet or touring as a whole, these artists have very little visibility off their particular website. Although there is an appearance of success, using any search engine and applying that artist name would yield very few actual results, meaning these acts are not as impactful as these sites would have you believe. Touring artists are still invisible on subscription and single sales websites, and the focus of these companies is to take web data and bring it to marketers, who then try to reach an audience. In one embodiment, the ranking system provides information regarding the artist's rank to consumers and is directed towards the audience. The ranking system may quantify and chart effort to sell music directly from the artist to the fan. That process should be protected for the intent of selling direct to consumer music. In one embodiment, the ranking system is not used specifically to build and track a marketing campaign(s). Rather, the purpose is to expose artists by effort so they can independently tour and sell music. In other embodiments, the ranking system may provide information to artists and other parties.

The lack of label purpose as a result of the ranking system means that artists no longer need label deals to survive. The end result is not only a new system of ranking, but a new reality for artists: full control and ownership of their product and a level playing field from which to gain exposure. In one embodiment, the ranking system is used to create chart positions on a retail Internet site allowing consumers to see viable music that they can purchase. Keeping everything on one site for the artist ignites casual foot traffic, promotes accidental discovery and reduces costs to the customer, as distribution, manufacturing, and retail buy-ins get eliminated. Better pricing can ignite purchases. Better deals mean artists keep more profit, and consumers pay less for product.

The opportunity is now open for any artist to gain exposure and sell music on a competitive level, while for the first time, maintaining complete ownership of their catalog. The ranking system creates a new platform from which to chart artists, and in turn, sell music. The ranking system eliminates chart manipulation, and monetary positioning. In an embodiment, the ranking system puts charting in the hands of the consumer as opposed to the industry, providing unobtrusive discovery unlike any other service.

The failure of today's discovery tools has led to decreases in album purchases, increases in illegal file sharing, decreases in artist exposure, and decreases in artist revenue. The growth and delayed gratification used by the ranking system to foster a career and create customer loyalty, as opposed to the instant gratification of current music systems, may be more beneficial to artists. The ranking system measures growth from the bottom up, as opposed to success from the top down. Additionally, traditional systems focus on data individually be it album sales, website metrics, touring data, etc. The ranking system is the first tool to synthesize the three main characteristics of an artist's career to capture a congruency that is a fair measurement, free from manipulation. Traditional systems use passive discovery. Passive discovery leads to subscriptions, singles sales, streaming services, all of which pay artists very little and fail to engage consumers. Traditional sites that allow artists to own and sell their own music simply do not allow for anyone to properly cut through the clutter. The ranking system uses vested, impactful, recognition. Vested fans purchase albums, buy merchandise and concert tickets.

The ranking system fragments the traditional music process. In the past, music was in the hands of the labels. They had the rights, money and control because the services they provided were highly specialized. The Internet has ushered in a new era providing artists with more options and flexibility. The current state of discovery may be a subscription identified by curation, because labels own catalog and want to license their catalog. Labels wish to be compensated and profitable by using their artists to create something to entice a customer. However, labels are not always successful in achieving this goal. Only a fraction of the music on subscription sites actually gets listened to per customer. This in turn benefits the labels because that model plays to their licensing and catalog strength. The ranking system puts ownership in the hands of the artist essentially doing away with future curation and label compensation. The ability to track Internet and street data, and analyze the relationship between the two to generate a picture of an artist's career and quantify the effort they are putting forth to develop can be done now with the ranking system. A website that simply allows artists to sell music will eventually run into the same traditional problems: how to determine website positioning, features, and promote artists, without offering the artist specific ways to improve exposure and affect their career.

Systems, apparatus, and methods described herein may be implemented using digital circuitry, or using one or more computers using well-known computer processors, memory units, storage devices, computer software, and other components. Typically, a computer includes a processor for executing instructions and one or more memories for storing instructions and data. A computer may also include, or be coupled to, one or more mass storage devices, such as one or more magnetic disks, internal hard disks and removable disks, magneto-optical disks, optical disks, etc.

Systems, apparatus, and methods described herein may be implemented using computers operating in a client-server relationship. Typically, in such a system, the client computers are located remotely from the server computer and interact via a network. The client-server relationship may be defined and controlled by computer programs running on the respective client and server computers. Gathering results by hand is tedious, time consuming, leaves room for error, and requires access to historical data to calculate items based on past performance and average totals, which are too voluminous when simply a handful of artists are signed on.

Systems, apparatus, and methods described herein may be used within a network-based cloud computing system. In such a network-based cloud computing system, a server or another processor that is connected to a network communicates with one or more client computers via a network. A client computer may communicate with the server via a network browser application residing and operating on the client computer, for example. A client computer may store data on the server and access the data via the network. A client computer may transmit requests for data, or requests for online services, to the server via the network. The server may perform requested services and provide data to the client computer(s). The server may also transmit data adapted to cause a client computer to perform a specified function, e.g., to perform a calculation, to display specified data on a screen, etc. For example, the server may transmit a request adapted to cause a client computer to perform one or more of the method steps described herein. Certain steps of the methods described herein may be performed by a server or by another processor in a network-based cloud-computing system. Certain steps of the methods described herein may be performed by a client computer in a network-based cloud computing system. The steps of the methods described herein may be performed by a server and/or by a client computer in a network-based cloud computing system, in any combination.

Systems, apparatus, and methods described herein may be implemented using a computer program product tangibly embodied in an information carrier, e.g., in a non-transitory machine-readable storage device, for execution by a programmable processor; and the method steps described herein may be implemented using one or more computer programs that are executable by such a processor. A computer program is a set of computer program instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

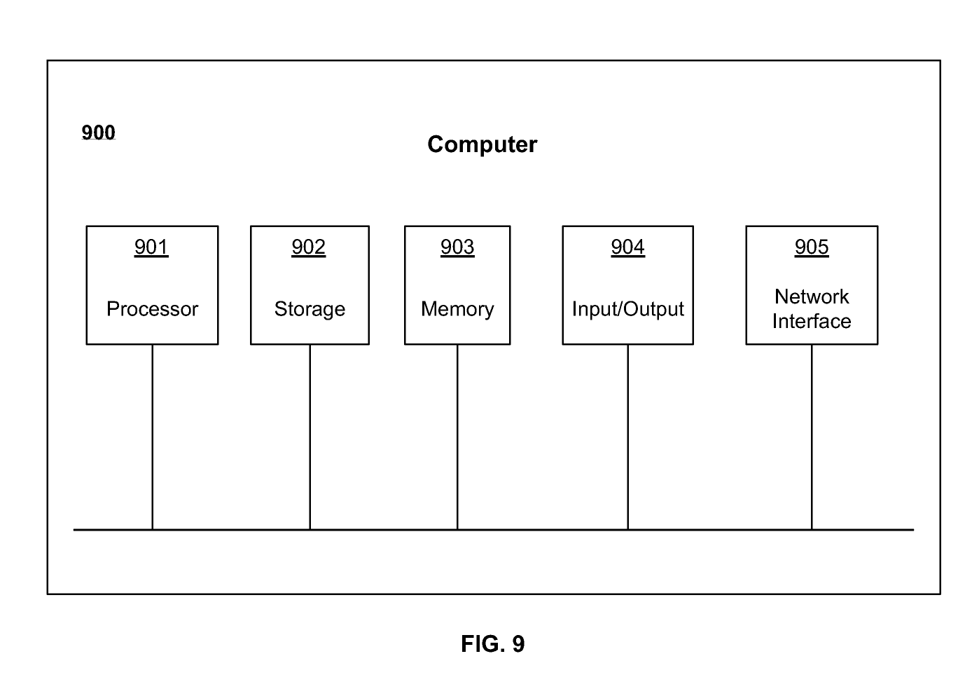

A high-level block diagram of an exemplary computer that may be used to implement certain systems, apparatus and methods described herein is illustrated in FIG. 9. Computer 900 includes a processor 901 operatively coupled to a data storage device 902 and a memory 903. Processor 901 controls the overall operation of computer 900 by executing computer program instructions that define such operations. The computer program instructions may be stored in data storage device 902, or other computer readable medium, and loaded into memory 903 when execution of the computer program instructions is desired. Thus, the method steps described herein can be defined by the computer program instructions stored in memory 903 and/or data storage device 902 and controlled by the processor 901 executing the computer program instructions. For example, the computer program instructions can be implemented as computer executable code programmed by one skilled in the art to perform an algorithm defined by the method steps described herein. Accordingly, by executing the computer program instructions, the processor 901 executes an algorithm defined by the method steps described herein. Computer 900 also includes one or more network interfaces 905 for communicating with other devices via a network. Computer 900 also includes one or more input/output devices 904 that enable user interaction with computer 900 (e.g., display, keyboard, mouse, speakers, buttons, etc.).

Processor 901 may include both general and special purpose microprocessors, and may be the sole processor or one of multiple processors of computer 900. Processor 901 may include one or more central processing units (CPUs), for example. Processor 901, data storage device 902, and/or memory 903 may include, be supplemented by, or incorporated in, one or more application-specific integrated circuits (ASICs) and/or one or more field programmable gate lists (FPGAs).

Data storage device 902 and memory 903 each include a tangible non-transitory computer readable storage medium. Data storage device 902, and memory 903, may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

Input/output devices 904 may include peripherals, such as a printer, scanner, display screen, etc. For example, input/output devices 904 may include a display device such as a cathode ray tube (CRT) or liquid crystal display (LCD) monitor for displaying information to the user, a keyboard, and a pointing device such as a mouse or a trackball by which the user can provide input to computer 900.

Any or all of the systems and apparatus discussed herein, including server 102, web service 104, user device 106, display 204, browser 202, memory 304, processor 302, ranking calculation metric 306, ranking database 308, data representing sales effort 310, data representing mailing list effort 312, data representing performance effort 314, data representing relationships 316, processor 402, memory 404, band/artist data 406, and components thereof, may be implemented using a computer such as computer 900.

One skilled in the art will recognize that an implementation of an actual computer or computer system may have other structures and may contain other components as well, and that FIG. 9 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A computer-implemented method of ranking a performance entity comprising:
calculating a change in sales associated with the performance entity, the amount of sales relative to the amount of users hearing an album, the change in sales, listens and views indicative of a difference between a first point quantity taken during a first time interval and a second point quantity taken during a second time interval, and a weekly sales result compared to an expected sales result;
calculating a list score based on a number of users associated with the performance entity, the number of users aggregated based on user data associated with a plurality of lists;
calculating a performance score of effort; and
determining, based on the change in sales, the list score and the performance score, a relative ranking of the performance entity among a plurality of performance entities.

2. The method of claim 1, wherein the relative ranking of the performance entity is periodically updated.

3. The method of claim 1, wherein the sales comprise purchases associated with the performance entity made at one or more websites.

4. The method of claim 1, wherein the calculating the list score further comprises calculating a value of a list change associated with the performance entity, the list change indicative of a difference between a first list quantity taken during a first time interval and a second list quantity taken during a second time interval.

5. The method of claim 1, wherein if one of the change in sales, the list score or the performance score is out of a particular range, determining an anomaly, and reducing overall weekly score positioning.

6. The method of claim 5, further comprising:
analyzing the anomaly to determine whether the relative ranking is accurate.

7. The method of claim 1, wherein the calculating the list score is further based on a number of users visiting a plurality of websites.

8. The method of claim 1, wherein the calculating the performance score is calculated based on at least one of: a show type, a position, a venue size, a radius, percentage of tickets sold, historical sales in a market.

9. An apparatus for ranking a performance entity comprising:
a processor; and a memory communicatively coupled to the processor, the memory to store computer program instructions, the computer program instructions when executed on the processor cause the processor to perform operations comprising:
calculating a change in sales/listens/visits associated with the performance entity, the change in sales/listens/visits indicative of a difference between a first point quantity taken during a first time interval and a second point quantity taken during a second time interval, calculating sales over expected sales and the conversion to sales from listeners;
calculating a list score based on a number of users associated with the performance entity, the number of users aggregated based on user data associated with a plurality of lists;
calculating a performance score; and
determining, based on the change in sales, the list score and the performance score, a relative ranking of the performance entity among a plurality of performance entities.

10. The apparatus of claim 9, wherein the relative ranking of the performance entity is periodically updated.

11. The apparatus of claim 9, wherein the sales comprise purchases associated with the performance entity made at one or more websites.

12. The apparatus of claim 9, wherein the calculating the list score further comprises calculating a value of a list change associated with the performance entity, the list change indicative of a difference between a first list quantity taken during a first time interval and a second list quantity taken during a second time interval.

13. The apparatus of claim 9, wherein if one of the change in sales, the list score or the performance score is out of a particular range, determining an anomaly.

14. The apparatus of claim 13, the operations further comprising:
analyzing the anomaly to determine whether the relative ranking is accurate.

15. The apparatus of claim 9, wherein the calculating the list score is further based on a number of users visiting a plurality of websites.

16. The apparatus of claim 9, wherein the calculating the performance score is calculated based on at least one of: a show type, a position, a venue size, a radius, percentage of tickets sold, history in a market.

17. A computer readable medium storing computer program instructions for ranking a performance entity, which, when executed on a processor, cause the processor to perform operations comprising:
calculating a change in sales associated with the performance entity, the change in sales indicative of a difference between a first sale quantity taken during a first time interval and a second sale quantity taken during a second time interval;
calculating a list score based on a number of users associated with the performance entity, the number of users aggregated based on user data associated with a plurality of lists;
calculating a performance score; and
determining, based on the change in sales, the list score and the performance score, a relative ranking of the performance entity among a plurality of performance entities.

18. The computer readable medium of claim 17, wherein the relative ranking of the performance entity is periodically updated.

19. The computer readable medium of claim 17, wherein if one of the change in sales, the list score or the performance score is out of a particular range, determining an anomaly.

20. The computer readable medium of claim 19, the operations further comprising:
analyzing the anomaly to determine whether the relative ranking is accurate.
